(19) United States
(12) Patent Application Publication
(10) Pub. No.: US 2006/0082810 A1
(43) Pub. Date: Apr. 20, 2006

(54) Instruction acceptance program and data processing system

(75) Inventors: Seiji Onishi, Osaka-shi (JP); Takanori Miyamoto, Osaka-shi (JP); Michiko Tashiro, Osaka-shi (JP); Kentarou Teshima, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 10/965,998

(22) Filed: Oct. 15, 2004

(51) Int. Cl. G06F 3/12

(52) U.S. Cl. 358/1.15

(57) ABSTRACT

An instruction acceptance program is provided which is capable of saving time and labor required if a user has to choose a driver individually when choosing and executing either faxing or printing. This instruction acceptance program is used for allowing: a display control portion to display, in a display portion of a personal computer, a processing choice message which prompts the input of an instruction to execute either faxing or printing (Si); and an acceptance portion to accept the instruction to execute either faxing or printing.

### BACKGROUND OF THE INVENTION

1. Field of the Invention

The present invention relates to an instruction acceptance program which is used to execute instruction acceptance processing of accepting an instruction on which processing should be executed, faxing or printing print data which is stored in a computer or the like, and a data processing system which executes the instruction acceptance processing.

2. Description of the Related Art

Conventionally, a computer is capable of faxing print data which is made up of document date, image date, or the like, and printing the print data using a printer which is connected through a network or the like. In such a case, for example, as disclosed in Japanese Patent Laid-Open No. 2000-224366, a driver for facsimile is supposed to be used when it faxes print data. On the other hand, when printing the print data using a printer, a printer driver is expected to be used which is separate from the facsimile driver.

As described above, if a separate driver is used for each of such faxing and printing, a user has to choose and operate a driver which corresponds to the faxing or the printing. Then, the user needs to set the size of a sheet of paper and the like for the faxing or the printing in each driver. Hence, if the user chooses a driver, that will take time and labor. In addition, each driver differs in how to operate them, thereby imposing a heavy operational burden on the user.

### SUMMARY OF THE INVENTION

In order to resolve the above described disadvantages, it is an object of the present invention to provide an operational-instruction acceptance program and a data processing system which are capable of saving time and labor required if a user has to choose a driver individually when choosing and executing faxing or printing, and which are easy to handle.

Hence, an instruction acceptance program according to the present invention for accepting an instruction to fax, or print, print data which is stored in a storage portion of a computer, based on an instruction by an external input, wherein the instruction acceptance program allows the computer to function as: a display controlling unit that displays, in a display portion of the computer, a processing choice message which prompts an input of the instruction to fax or print the print data; and an accepting unit that accepts the instruction to fax or print the print data from the external input when the processing choice message is displayed by the display controlling unit.

According to this configuration, a processing choice message is displayed in a display portion of a computer which prompts an input of an instruction on which processing should be executed, faxing or printing. Then, when this processing choice message is displayed, an instruction can be inputted on which processing should be executed, faxing or printing. Therefore, a user does not need to choose and operate a driver which corresponds to each of faxing and printing, thus saving time and labor. This makes it possible to use each of faxing and printing, as the need arises, with simple handling.

These and other objects, features and advantages of the present invention will become more apparent upon reading of the following detailed description along with the accompanied drawings.

### BRIEF DESCRIPTION OF THE DRAWINGS

FIG. 1 is a block diagram, showing a personal computer in which an instruction acceptance program according to the present invention is installed, and a printer and a facsimile machine which are connected to this.

FIG. 2 is a flow chart, showing faxing and printing by a personal computer in which a print-data output control program is installed.

FIGS. 3A and 3B are representations, showing examples of a display screen which prompts a user to choose faxing or printing.

FIG. 4 is a flowchart according to a second embodiment of the present invention, showing faxing and printing by a personal computer in which a print-data output control program is installed.

FIG. 5 is a flow chart according to a third embodiment of the present invention, showing faxing and printing by a personal computer in which a print-data output control program is installed.

FIG. 6 is a representation, showing an example of a display screen for confirmation.

FIG. 7 is a flow chart according to a fourth embodiment of the present invention, showing faxing and printing by a personal computer in which an instruction acceptance program is installed.

FIG. 8 is a flow chart according to a fifth embodiment of the present invention, showing faxing and printing by a personal computer in which an instruction acceptance program is installed.

FIG. 9A is a representation, showing an example of a display screen for confirmation at the time when printing is chosen. FIG. 9B is a representation, showing an example of a display screen for confirmation at the time when faxing is chosen.

FIG. 10 is a flow chart according to a sixth embodiment of the present invention, showing faxing and printing by a personal computer in which an instruction acceptance program is installed.

FIG. 11 is a representation, showing an example of a display screen which prompts a user to choose faxing or printing.

FIG. 12 is a block diagram, showing a substantial configuration of a data processing system according to the present invention.

FIG. 13 is a flowchart, showing the flow of processing in the case where printing and faxing are executed by a data processing system 10.

FIG. 14 is a flow chart according to the second embodiment, showing processing in the case where printing and faxing are executed by the data processing system 10.

FIG. 15 is a flow chart according to the third embodiment, showing processing in the case where printing and faxing are executed by the data processing system 10.

FIG. 16 is a block diagram, showing a substantial configuration of a data processing system according to the second embodiment.

FIG. 17 is a flowchart, showing the flow of processing in the case where printing and faxing are executed by a data processing system 11 according to the second embodiment.

FIG. 18 is a flow chart according to the second embodiment, showing processing in the case where printing and faxing are executed by the data processing system 11.

FIG. 19 is a flow chart according to the third embodiment, showing processing in the case where printing and faxing are executed by the data processing system 11.

### DETAILED DESCRIPTION OF THE PREFERRED EMBODIMENTS

Hereinafter, an instruction acceptance program according to an embodiment of the present invention will be described with reference to the drawings.

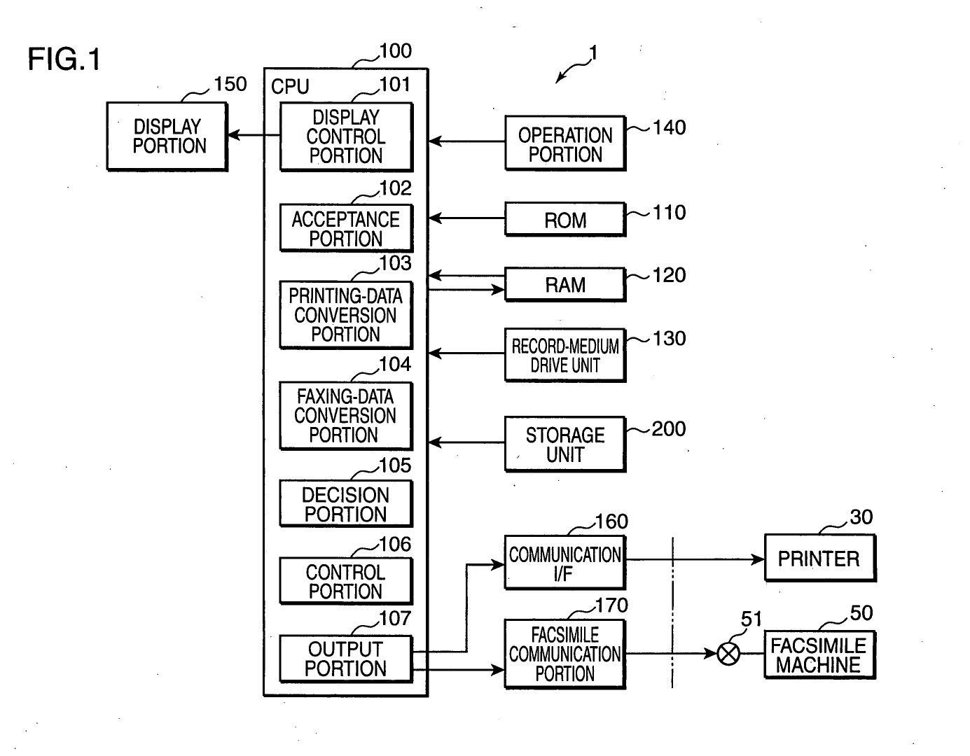

FIG. 1 is a block diagram, showing a personal computer (hereinafter, referred to as the PC) in which the instruction acceptance program according to the present invention is installed, and a printer and a facsimile machine which are connected to this.

The PC 1 is connected to a printer 30, via a LAN (or local area network) cable, a parallel cable such as a Centronics interface, a serial cable such as RS-232C, or the like. Print data which is outputted from the PC 1 is printed on record paper by the printer 30. Herein, a communication I/F 160 functions as a LAN interface, a parallel I/F portion, or a serial I/F portion. The printer 30 includes various apparatuses which are provided with a printer function, such as a combined machine with a facsimile function, a printer function and a copying function, and a facsimile machine.

A facsimile communication portion 170 is used to control data necessary for facsimile communication. It transmits and receives data to and from a facsimile machine 50, through a public circuit 51. The facsimile communication portion 170 is provided with an NCU (or network control unit) which controls the connection of a telephone line with the facsimile machine 50 to and from which it transmits and receives data, or the like.

The PC 1 includes: the above described communication I/F 160 and facsimile communication portion 170; a CPU 100; an ROM (or read-only memory) 110; an RAM (or random-access memory) 120; a record-medium drive unit 130; an operation portion (i.e., an input unit) 140; a display portion 150; and a storage unit (i.e., a storage portion) 200.

In the ROM 110, there is stored a BIOS (or basic input/output system) which is a basic program for controlling peripheral equipment such as the storage unit 200 and the record-medium drive unit 130, or the like. The RAM 120 is used as a working area of the CPU 100 to store various pieces of data temporarily. The record-medium drive unit 130 reads, under the control of the CPU 100, various pieces of data which are recorded in a record medium, such as a CD-ROM, a flexible disk and a DVD (or digital versatile disk). Herein, in addition to the storage unit 200, the storage portion according to the claims also includes the RAM 120, a record medium which is read by the record-medium drive unit 130, and a record medium such as a hard disk attached from the outside which is connected to the PC 1.

The operation portion 140 includes a keyboard, a mouse and the like. It accepts an operational instruction by a user, and outputs, to the CPU 100, an electric signal according to the operational instruction. The display portion 150 is made up of a liquid-crystal panel, a CRT (or cathode-ray tube) or the like. It displays various images under the control of the CPU 100.

The storage unit 200 is made up, for example, of a magnetic disk. In it, there is stored an operating system which is a basic program for controlling a personal computer systematically, the instruction acceptance program according to the present invention, or the like. Based on an instruction which is inputted in an acceptance portion 102 from the outside, the instruction acceptance program is supposed to selectively fax, or print, print data which is stored in the storage unit 200 or the like of the PC1. In the case where the instruction acceptance program is stored in a record medium, which also forms an aspect and embodiment of the present invention, such as a CD-ROM and a flexible disk, this record medium is loaded and installed into the record-medium drive unit 130. Thus, it is stored in the storage unit 200. On the other hand, in the case where the instruction acceptance program is stored in a Web server on the Internet, the instruction acceptance program may also be downloaded from the Web server. Thereby, such a program is stored in the storage unit 200.

The CPU 100 executes the instruction acceptance program under the control of an operating system. Thus, it functions as: a display control portion (i.e., the display control unit, the instruction-content display controlling unit, the required-item display controlling unit and the lacked item display controlling unit) 101; an acceptance portion (i.e., the first to third accepting unit and the final-instruction accepting unit) 102; a printing-data conversion portion (i.e., the printing-data converting unit) 103; a faxing-data conversion portion (i.e., the faxing-data converting unit) 104; a decision portion (i.e., the deciding unit) 105; a control portion (i.e., the controlling unit) 106; and an output portion (i.e., the outputting unit) 107.

The display control portion 101 displays, in the display portion 150, a processing choice message which prompts an input of an instruction on which processing should be executed, faxing or printing, a required item which should be set at the minimum whichever may be executed, faxing or printing, or the like.

When the above described processing choice message is displayed in the display portion 150 by the display control portion 101, the acceptance portion 102 accepts, from an external input by a user, an instruction on which processing should be executed, faxing or printing. In addition, when the above described required item is displayed by the display control portion 101, the acceptance portion 102 accepts an instruction to set this required item from the external input.

The printing-data conversion portion 103 converts the print data into a data format for printing (e.g., a PDL (or page description language)). The faxing-data conversion portion 104 converts the print data into a data format suitable for faxing (e.g., raster data). The decision portion 105 decides whether or not the required item which is displayed in the display portion 150 by the display control portion 101 has been set, without any shortage, based on the setting instruction which has been accepted by the acceptance portion 102. Herein, if the decision portion 105 decides there is a required item in short supply, the display control portion 101 displays, in the display portion 150, the fact that there is a required item in short supply.

The control portion 106 allows, based on the instruction and the instruction to set the above described required item which have been inputted in the acceptance portion 102 by a user, either the printing-data conversion portion 103 or the faxing-data conversion portion 104 to convert the print data. The output portion 107 outputs the data which has been converted by the printing-data conversion portion 103 to the printer 30, via the communication I/F 160. In addition, it outputs the data which has been converted by the faxing-data conversion portion 104 to the facsimile communication portion 170. The data which has been received by the facsimile communication portion 170 is transmitted through the public circuit 51 to the external facsimile machine 50.

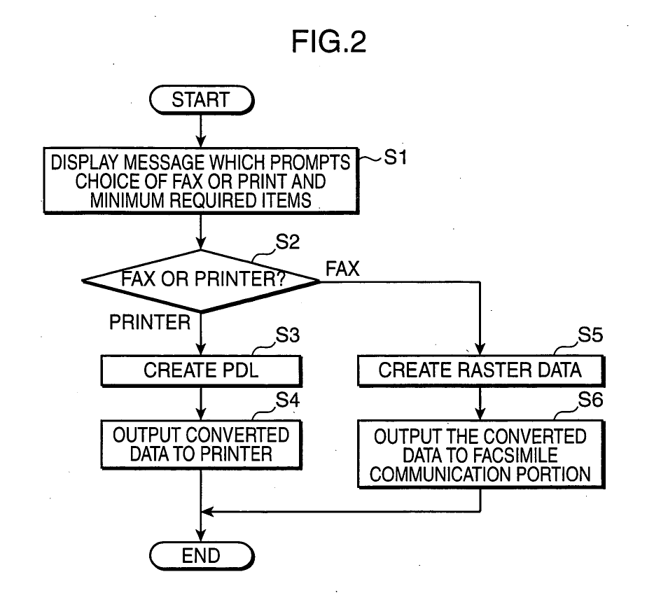

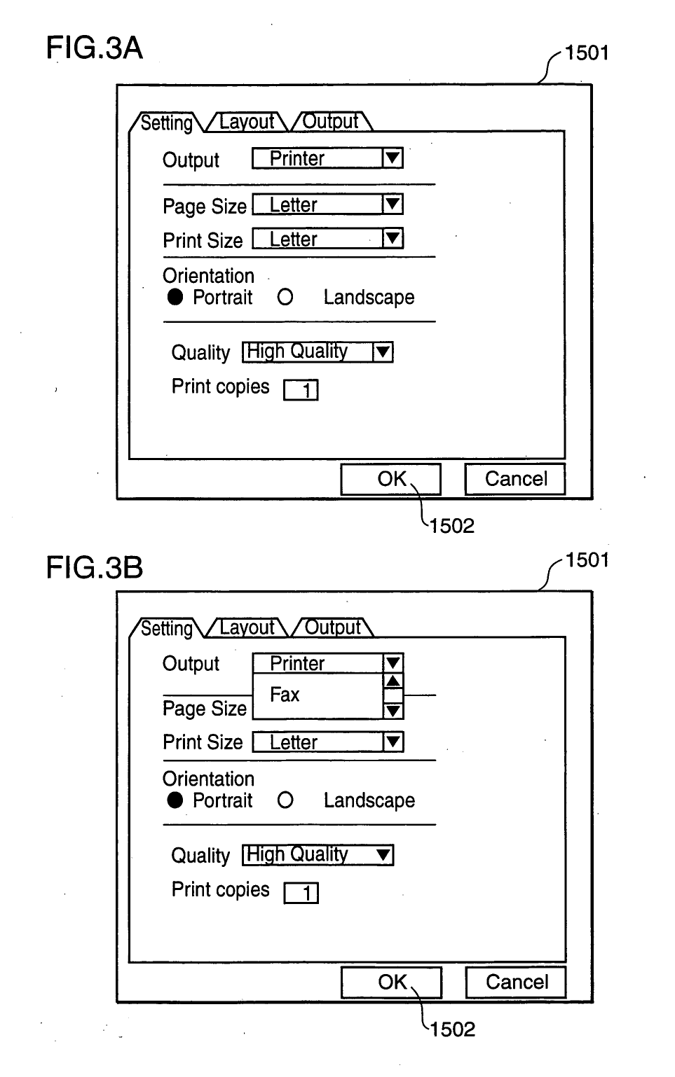

Next, printing and faxing will be described which are executed by the PC 1 in which a print-data output control program is installed. FIG. 2 is a flow chart, showing faxing and printing by the PC 1 in which the print-data output control program is installed. FIGS. 3A and 3B are representations, showing examples of a display screen which prompts a user to choose faxing or printing.

First, a user gives an instruction to operate the print-data output control program. Then, the display control portion 101 displays, in the display portion 150, the processing choice message which prompts the user to choose faxing or printing, and the required item which should be set at the minimum which ever may be executed, faxing or printing, or the like (S1). This processing choice message is shown, for example, on a display screen 1501 in FIG. 3A. On this display screen 1501, an “Output” column is displayed as a processing choice message for choosing where the print data is to be outputted. Inside of a long bar of this column, there is displayed processing (i.e., where it is to be outputted) which can be chosen. If you press a “▾” mark which is displayed at an end of this long bar, as shown in FIG. 3B, there are displayed all items of processing (i.e., Printer and Fax) which can be chosen.

When printing and faxing are displayed as all items of processing which can be chosen, a user chooses desired processing, using the operation portion 140 (i.e., a mouse) Thereby, an instruction to execute the processing which has been chosen by the user is accepted by the acceptance portion 102.

As the above described required items, for example, as shown on the display screen 1501 in FIG. 3A, there are displayed the size of original paper (i.e., Page Size), the size of output paper (i.e., Print Size), the orientation of paper at the time of printing (i.e., Orientation), the quality of printing (i.e., Quality), the number of copies (i.e., Print Copies), and the like. In this case, in the same way as the above described processing display, inside of a long bar of each column, there are displayed sizes or qualities which can be chosen. If you press a “▾” mark which is displayed at an end of this long bar, there are displayed all sizes or qualities (i.e., Printer and Fax) which can be chosen. When the sizes or qualities which can be chosen are displayed inside of each bar, a user chooses a desired size or quality, using the operation portion (i.e., a mouse pointer) 140. Thereby, an instruction to execute the processing at the size or quality which has been chosen by the user is accepted by the acceptance portion 102.

With respect to the orientation of paper, the user chooses whether to use sheets of paper with the shorter side at the top (i.e., Portrait), or with the longer side at the top (i.e., Landscape), by clicking a “603 ” mark of the “Orientation” column shown in FIG. 3A, using the operation portion (i.e., a mouse pointer) 140. When a “◯” mark is chosen, it turns into a “●” mark. In addition, with respect to the number of copies, the figure (i.e., the value which is equivalent to the number of copies) which is desired by the user is inputted in the “Print Copies” column from the operation portion 140. Then, if the user presses an OK button on the display screen 1501, a processing choice instruction and each required-item setting instruction which have been operated using the display screen 1501 are sent out to and accepted by the acceptance portion 102.

Herein, a default value is preset for each of the above described processing and required items. Thus, even though the user does not set them, the processing is executed based on the default value.

Again, the flow chart in FIG. 2 will be described. As described above, if the user chooses printing, the acceptance portion 102 accepts this instruction as the final instruction (i.e., “printer” in a step S2). At the same time, the acceptance portion 102 accepts, as the final instruction, the instruction to set a required item which is displayed on the display screen 1501. Then, the control portion 106 allows, based on the setting content of the required item which has been accepted by the acceptance portion 102, the printing-data conversion portion 103 to convert the print data to be outputted and create PDL data (S3). Then, the created PDL data is outputted from the output portion 107 via the communication I/F 160 to the printer 30 (S4).

On the other hand, as described above, if the user chooses faxing, the acceptance portion 102 accepts this instruction as the final instruction (i.e., “fax” in the step S2). Then, the control portion 106 allows, based on the setting of the required item which has been simultaneously accepted by the acceptance portion 102, the faxing-data conversion portion 104 to convert the print data to be outputted and create raster data (S5). Then, the created raster data is outputted from the output portion 107 to the facsimile communication portion 170 (S6). Then, the facsimile communication portion 170 transmits that data to the facsimile machine 50 at its destination, through a public circuit 51.

Hence, a processing choice message which prompts a choice of faxing or printing is displayed in the display portion 150 by the display control portion 101. Then, based on an instruction which is inputted from a user according to this processing choice message, the printing-data conversion portion 103 or the faxing-data conversion portion 104 is chosen. Next, it executes a conversion of the print data. Sequentially, the converted print data is outputted based on that data format to either a printer or a facsimile machine. Therefore, the user does not need to choose and operate a driver which corresponds to each of faxing and printing, thus saving time and labor. This makes it possible to use each of faxing and printing, as the need arises, with simple handling.

In addition, a required item which should be set at the minimum in both cases where the print data is faxed and printed is displayed in the display portion 150. Then, if an instruction to set this displayed required item is accepted, then based on the accepted setting instruction, the printing-data conversion unit or the faxing-data conversion unit executes a conversion of the print data. Therefore, whichever is executed, faxing or printing, the user can set a required item which is common to faxing and printing, on the same display screen 1501.

Herein, the present invention is not limited to the configuration of the above described embodiment, and thus, it can be varied. For example, in the above described embodiment, the size of original paper (i.e., Page Size), the size of output paper (i.e., Print Size), the orientation of paper at the time of printing (i.e., Orientation), the quality of printing (i.e., Quality), the number of copies (i.e., Print Copies) are displayed as an example of required items which should be set on the display screen 1501 (see FIG. 2). However, the required items according to the present invention are not limited to these. Besides, the method of pressing the “▾” button is described to set processing and each required item. However, another method may also be used, for example, inputting a numerical value such as the size of paper, using a keyboard.

Furthermore, in the first embodiment, the display control portion 101 displays, in the display portion 150, a processing choice message which prompts a choice of faxing or printing and a required item which should be set at the minimum in both cases where the print data is faxed and printed (in the step S1 of FIG. 2). However, the display control portion 101 may not display the required item. In that case, if an instruction to choose faxing or printing is inputted, the control portion 106 allows either the printing-data conversion portion 103 or the faxing-data conversion portion 104 to convert the print data.

Moreover, in the above described embodiment, according to which converts the print data, the printing-data conversion portion 103 or the faxing-data conversion portion 104, the destination to which the data is outputted from the output portion 107 is the printer 30 or the facsimile communication portion 170. However, even in both cases where the data which is outputted from the personal computer 1 is printed and faxed, as long as one and the same combined machine (i.e., an image forming apparatus with several functions such as a facsimile function, a printer function and a copying function) is used, the destination to which the data is outputted from the output portion 107 becomes that combined machine, whichever converts the print data, the printing-data conversion portion 103 or the faxing-data conversion portion 104. In that case, the processing which is executed by the facsimile communication portion 170 is executed by such a combined machine.

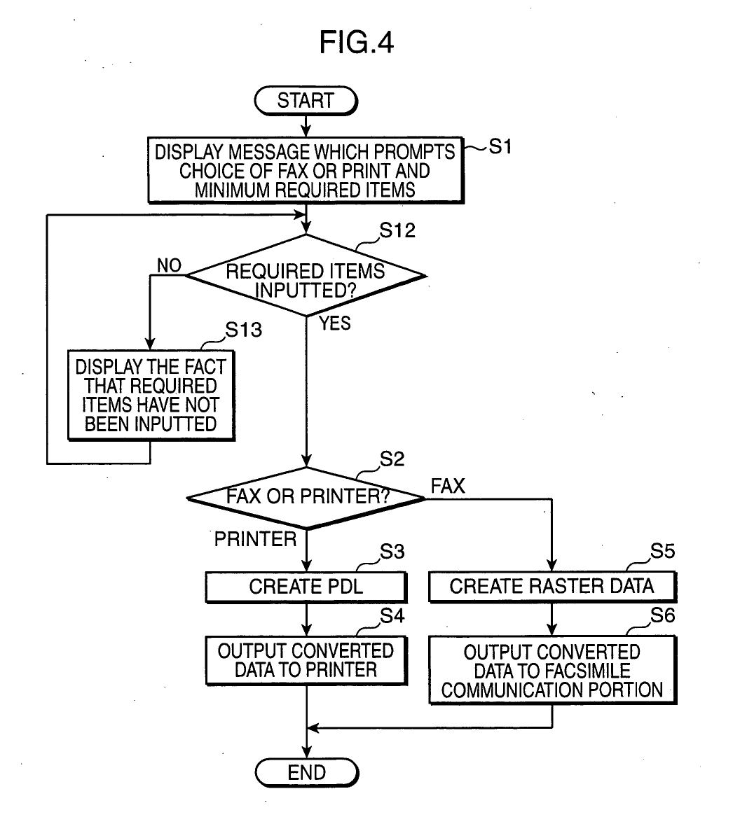

Next, printing and faxing according to a second embodiment of the present invention will be described which is executed by the PC 1 in which a print-data output control program is installed. FIG. 4 is a flow chart according to the second embodiment, showing faxing and printing by the PC 1 in which the print-data output control program is installed. Herein, the second embodiment is described with reference to FIG. 4, as well as the above described FIG. 3. In addition, in FIG. 4, the same characters and numerals as those in FIG. 2 are given in its identical processing as in FIG. 2, and thus, their description is omitted.

In the above described first embodiment, a default value is preset for the processing and each required item. Thus, even though a user does not set them, the processing is executed based on the default value. In contrast, in the second embodiment, no default value is preset for the processing and each required item. Thus, unless a user sets required items which are displayed on the display screen 1501, the display control portion 101 allows the display portion 150 to display the fact that the required items are not set. Thus, after the required items are inputted, faxing or printing is executed.

In the second embodiment, the display control portion 101 displays, in the display portion 150, the processing choice message which prompts the user to choose faxing or printing (S1). Thereafter, the decision portion 105 decides whether or not the required item is inputted (S12).

Herein, if the decision has been made that the setting by the user is inadequate and there is an required item which has not yet been set (i.e., if it is NO at the step S12), then the display control portion 101 allows the display portion 150 to display the fact that there is an required item in short supply (S13). The case where the setting of an required item is not enough includes, for example, the one in which the numerical value of the number of copies (i.e., Print Copies) has not yet been inputted, and in that state, an OK button 1502 on the display screen 1501 is pressed down. After the above described display at the step S13, if the decision portion 105 decides that the required item has been set by the user (i.e., if it is YES at the step S12), then a data conversion for faxing or printing is executed based on the instruction which has been inputted in the acceptance portion 102 from the user (S2 to S6).

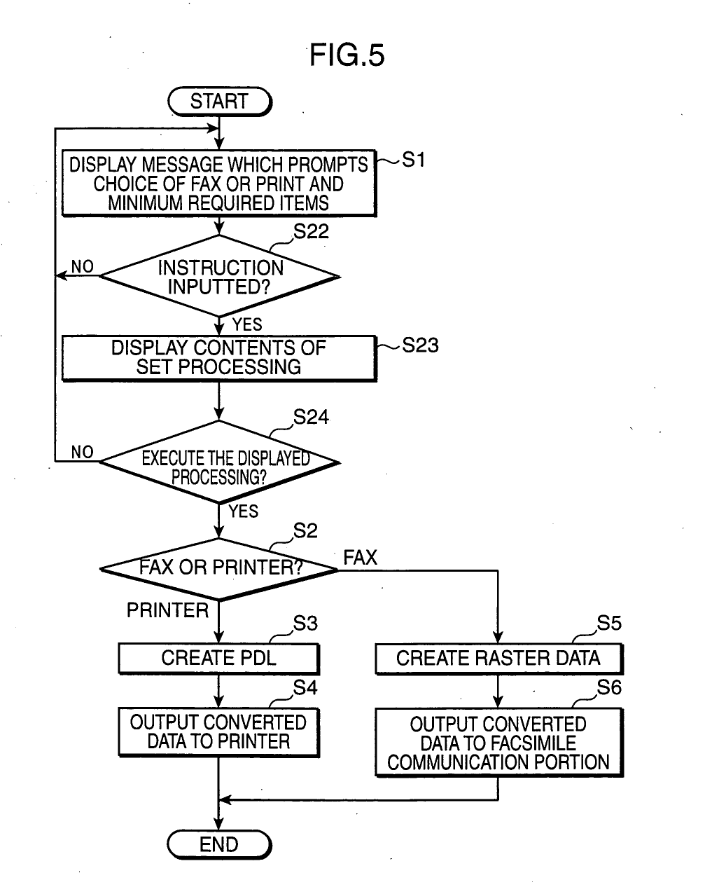

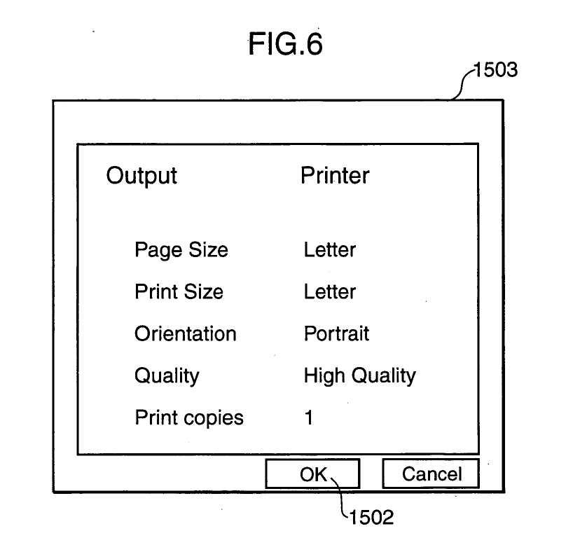

Next, printing and faxing according to a third embodiment of the present invention will be described which is executed by the PC 1 in which a print-data output control program is installed. FIG. 5 is a flow chart according to the third embodiment of the present invention, showing faxing and printing by the PC 1 in which the print-data output control program is installed. FIG. 6 is a representation, showing an example of a display screen for confirmation. Herein, the same characters and numerals as those in FIG. 2 and FIG. 4 are given in its identical processing as in FIG. 2 and FIG. 4, and thus, their description is omitted.

In the case where the processing according to the third embodiment is executed, in addition to the contents which are described using the above described FIG. 1, the display control portion 101 further allows the display portion 150 to display a display screen (see FIG. 6) for confirmation which shows whether the instruction which has been accepted by the acceptance portion 102 as the instruction which corresponds to the processing choice message (see FIG. 3) is for faxing or printing, or the like. Besides, in addition to the contents which are described using FIG. 1, when the display screen for confirmation is displayed in the display portion 150 by the display control portion 101, the acceptance portion 102 further accepts, from an external input by the user, an instruction to execute this displayed processing (i.e., faxing or printing).

The processing according to the third embodiment will be described, using FIG. 5 and FIG. 6. The display control portion 101 displays, in the display portion 150, the processing choice message which prompts the user to choose faxing or printing, and the required item which should be set at the minimum whichever may be executed, faxing or printing (S1). At this time, if the acceptance portion 102 accepts an instruction to set the print-data processing and each required item which come in from the user (i.e., if it is YES at a step S22), then the display control portion 101 allows the display portion 150 to display the contents of the print-data processing and each required item which have been set based on this instruction, for example, using such a confirmation screen 1503 as shown in FIG. 6 (S23).

Then, the user operates the operation portion 140 and presses a Cancel button 1505 of this confirmation screen 1503. Thereby, an instruction not to execute the processing which has been displayed in the display portion 150 is accepted by the acceptance portion 102 (i.e., it is NO at a step S24). Thus, the processing returns to the step S1. Then, the display control portion 101 displays again, in the display portion 150, the processing choice message which prompts the user to choose faxing or printing, and the required item which should be set at the minimum whichever may be executed, faxing or printing.

On the other hand, if the user presses the OK button 1502 of the confirmation screen 1503, then an instruction to execute the processing which has been displayed in the display portion 150 is accepted by the acceptance portion 102 (i.e., it is YES at the step S24). Thus, the acceptance portion 102 accepts this instruction as the final instruction. Then, the control portion 106 judges which of faxing and printing has been chosen by the user (S2). After this, the processing is executed in the steps S3 to S6 shown in FIG. 2.

Hence, in the third embodiment, the contents which have been set by the user are displayed in the display portion 150 before faxing or printing is executed. Then, the user can confirm them, thus preventing the user from mistakenly inputting faxing or printing.

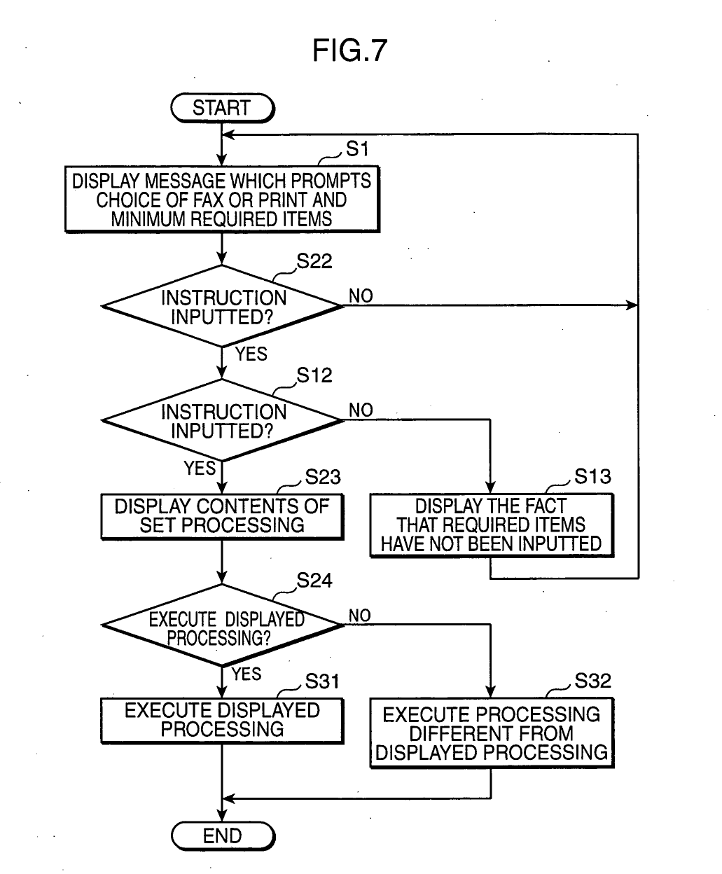

Next, printing and faxing according to a fourth embodiment of the present invention will be described which is executed by the PC 1 in which an instruction acceptance program is installed. FIG. 7 is a flow chart according to the fourth embodiment of the present invention, showing faxing and printing by the PC 1 in which the instruction acceptance program is installed. Herein, the same characters and numerals as those in FIG. 5 are given in its identical processing as in FIG. 5, and thus, their description is omitted.

In the fourth embodiment, when required items are not set, the display control portion 101 allows the display portion 150 to display the fact that required items are not set. After required items are inputted, the display control portion 101 displays the confirmation display screen 1503 (see FIG. 6) which shows the inputted contents. In addition, while the display control portion 101 is displaying the confirmation display screen 1503, if an instruction not to execute the processing and the processing of each required item which is displayed on the confirmation display screen 1503 are inputted by the user, and this instruction is accepted by the acceptance portion 102, then the processing which is not displayed on the confirmation display screen 1503 is designed to be executed.

A description is given using FIG. 7. First, the display control portion 101 allows the display portion 150 to display the confirmation display screen 1503 (see FIG. 6) which shows the contents inputted by the user (S23). Thereafter, if an instruction from the user to execute the instruction which is displayed in the display portion 150 is accepted by the acceptance portion 102 (i.e., if it is YES at the step S24), then the control portion 106 executes the processing which is displayed on the confirmation display screen 1503 (S31). On the other hand, if an instruction not to execute the processing which is displayed on the confirmation display screen 1503 is accepted by the acceptance portion 102 (i.e., if it is NO at the step S24), then the control portion 106 executes the processing different from the one which is displayed on the confirmation display screen 1503 (S32). After the processing of the steps S31 and S32, the processing is executed in the same way as in the steps S3 to S6 in FIG. 5.

Therefore, if the user wants to execute the processing different from the one which is displayed on the confirmation display screen 1503, the user can quickly execute this different processing without resetting the processing.

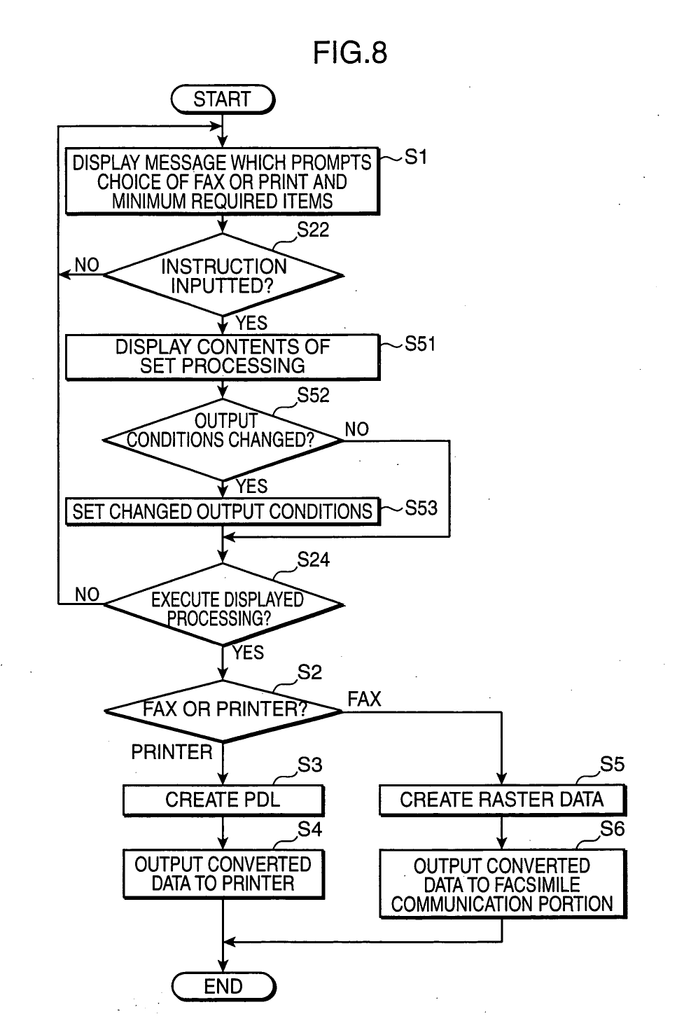

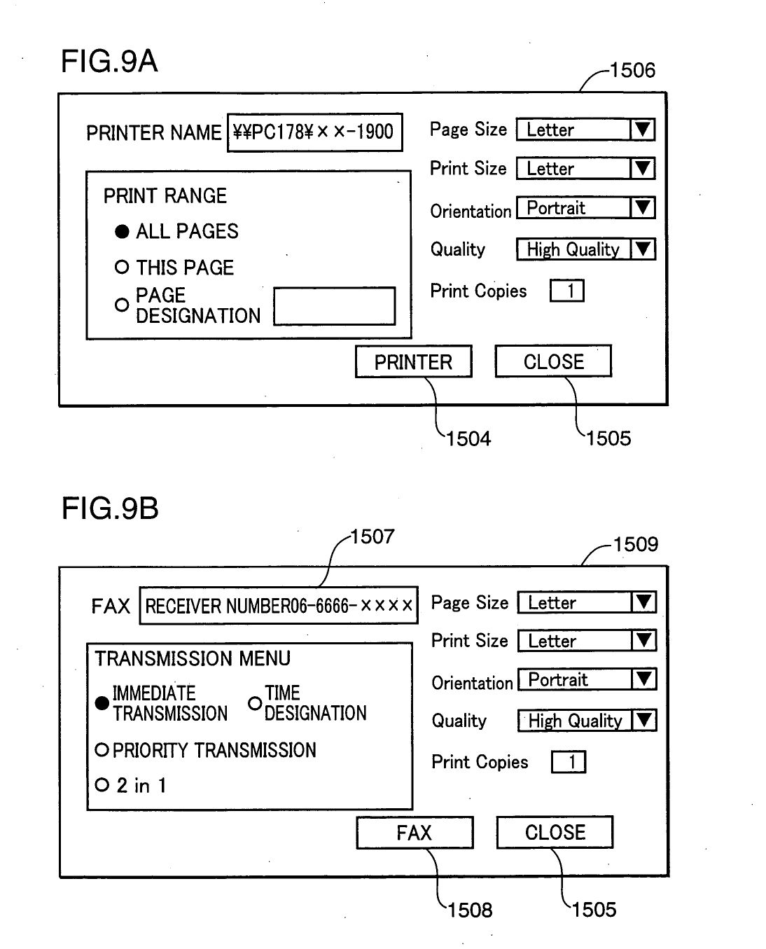

Next, printing and faxing according to a fifth embodiment of the present invention will be described which is executed by the PC 1 in which an instruction acceptance program is installed. FIG. 8 is a flow chart according to the fifth embodiment, showing faxing and printing by the PC 1 in which the instruction acceptance program is installed. FIG. 9A is a representation, showing an example of a display screen for confirmation at the time when printing is chosen. FIG. 9B is a representation, showing an example of a display screen for confirmation at the time when faxing is chosen. Herein, the same characters and numerals as those in the flow chart of each figure described earlier are given in its identical processing, and thus, their description is omitted.

Next, in the case where the processing according to the fifth embodiment is executed, if the acceptance portion 102 accepts an instruction for a processing choice message (see FIG. 3), based on the contents of the accepted instruction, the display control portion 101 shows whether it is for faxing or printing, and the contents of the set output condition. In addition, it allows the display portion 150 to display a confirmation display screen 1506 or a confirmation display screen 1509 (see FIGS. 9A and 9B), so that the output condition can be reset.

When the confirmation display screen 1506 or 1509 is displayed in the display portion 150 by the display control portion 101, the acceptance portion 102 accepts, from an external input by the user's operation, an instruction to change the setting of the output condition, and an instruction to execute this displayed processing (i.e., faxing or printing).

A description is given using FIG. 8. First, the display control portion 101 displays, in the display portion 150, the processing choice message which prompts the user to choose faxing or printing, and the required item which should be set at the minimum which ever may be executed, faxing or printing (S1). This processing choice message is, for example, the same as that shown in FIGS. 3A and 3B.

Then, by the user's operation, a processing choice instruction to choose printing or faxing (or both a processing choice instruction and an output-condition choice instruction, if an output-condition setting instruction to set the required item is inputted by the user) is inputted. Then, if the acceptance portion 102 accepts this instruction (i.e., if it is YES at the step S22), then the display control portion 101 allows the display portion 150 to display the contents of the print-data processing (i.e., either printing or faxing) and each required item which have been set based on this instruction, for example, using such a confirmation screen 1506 or 1509 as shown in FIGS. 9A and 9B (S51).

For example, the case is described where printing is chosen based on this processing choice instruction. In this case, the confirmation screen 1506 shown in FIG. 9A is displayed. On this screen, there are displayed the name of a printer which is set based on a default value, and again, the contents of the output conditions which are set on the above described display screen 1501 (see FIG. 3). These output conditions can be reset by the same operation as the one on the display screen 1501. The name of a printer can be changed, using the operation portion 140 (such as a keyboard).

In addition, on the confirmation screen 1506, there is displayed a message to designate the range of printing which is not displayed on the display screen 1501. Thus, the printing range can be set on the confirmation screen 1506. For example, a user clicks the “◯” mark of an “All Pages” column, or a “This Page” column, of a “Print Range”, using the operation portion 140 (such as a mouse pointer) Thereby, the user can choose to print all the pages, or only the page which is displayed in an application that the user is using at a point of time. The “◯” mark in the chosen column is replaced with a “●” mark. In addition, if the user clicks the “◯” mark of a “Page Designation” column, the “◯” mark is replaced with a “●” mark, so that the user can set an input of the page to be printed, using the operation portion 140 (i.e., a keyboard). Then, if the page to be printed which has been inputted from the operation portion 140 (i.e., a keyboard) is accepted by the acceptance portion 102, the values of the inputted pages are displayed inside of the box which is displayed next to the “Page Designation.” Herein, the default value of this printing range is set, so that all the pages will be printed.

Furthermore, at the lower part of the confirmation screen 1506, there is displayed “Printer” which is the processing chosen based on the above described processing choice instruction. If the user designates a “Printer” display part 1504, using the operation portion 140 (such as a mouse pointer), then an instruction to execute printing is accepted by the acceptance portion 102. On the other hand, if the user designates a “Close” display part 1505, using the operation portion 140 (such as a mouse pointer), then the display control portion 101 is designed to display the display screen 1501 again.

Next, the case is described where faxing is chosen based on the above described processing choice instruction. In this case, the confirmation screen 1509 shown in FIG. 9B is displayed. On this screen, there are displayed a box which shows the number of the destination to which the print data is faxed, and again, the contents of the output conditions which are set on the above described display screen 1501. The destination to which the print data is faxed can be set, using the operation portion 140 (such as a keyboard and a ten-key).

In addition, on the confirmation screen 1509, there is displayed a message to designate a transmission menu which is not displayed on the display screen 1501. Thus, the transmission menu can be set on the confirmation screen 1509. For example, a user clicks the “◯” mark of an “Immediate Transmission”, or an “Time Designation” column, of a “Transmission Menu” display part, using the operation portion 140 (such as a mouse pointer). Thereby, the user can choose to execute faxing immediately, or execute faxing at the time which the user has designated. In the same way as the case of the confirmation screen 1503, the “◯” mark in the chosen column is replaced with a “●” mark. Herein, the default value of this transmission menu is set at the “Immediate Transmission.”

Furthermore, at the lower part of the confirmation screen 1509, there is displayed “Fax” which is the processing chosen based on the above described processing choice instruction. If the user designates a “Fax” display part 1508, using the operation portion 140 (such as a mouse pointer), then an instruction to execute the faxing is accepted by the acceptance portion 102.

Again, a description is given using FIG. 8. If a user operates the operation portion 140 while the confirmation display screen 1506 or 1509 is displayed, then an instruction to change output conditions, such as the size of original paper (i.e., Page Size), the size of output paper (i.e., Print Size), the orientation of paper at the time of printing (i.e., Orientation), the quality of printing (i.e., Quality) and the number of copies (i.e., Print Copies), or the default value of the printing-range setting, are accepted (i.e., it is YES at a step S52). Thereby, the control portion 106 changes the output conditions or the printing range which have already been set, into the contents of the instruction to change them (S53).

Then, the user presses the “Close” button 1505 of this confirmation display screen 1506 or 1509, using the operation portion 140 (i.e., a mouse). Thereby, an instruction not to execute the processing which has been displayed in the display portion 150 is accepted by the acceptance portion 102 (i.e., it is NO at the step S24). Thus, the control portion 106 returns the processing to the step S1. Then, the display control portion 101 displays again, in the display portion 150, the display screen 1501 which is made up of the processing choice message which prompts the user to choose faxing or printing, and the required item which should be set at the minimum whichever may be executed, faxing or printing.

On the other hand, if the user designates the “Printer” button 1504 of the confirmation screen 1506, or the “Fax” button 1508 of the confirmation screen 1509, then an instruction to execute the print-data processing which has been displayed in the display portion 150 is accepted by the acceptance portion 102 (i.e., it is YES at the step S24). Thus, the acceptance portion 102 accepts this instruction and the output-condition setting which it has accepted at the steps S2 and S5, as the final instruction. Then, the control portion 106 judges which of faxing and printing has been chosen by the user (S2). After this, the processing is executed in the steps S3 to S6 shown in FIG. 2.

Hence, on the confirmation screen 1506 or 1509, a user can reconfirm whether the print-data processing to be executed is printing or faxing. Besides, the user can reset the output conditions which have been set on the display screen 1501, so that the user can change the output conditions or execute such an operation, without returning to the display screen 1501. In addition, on the confirmation screen 1506 or 1509, a user can newly set a printing range or a faxing menu, so that the user can set an item which needs setting separately in each of printing and faxing.

In the fifth embodiment, on the confirmation screen 1506 or 1509, the output conditions and printing range which have been set on the display screen 1501 is designed to be displayed. However, the following three operations may also be executed: (1) displaying only new items different from the ones which have been set on the display screen 1501; (2) unless the default values of the printing output conditions are set on the display screen 1501, detecting and displaying the items which have not yet been set; and (3) displaying only the above described printing-range item.

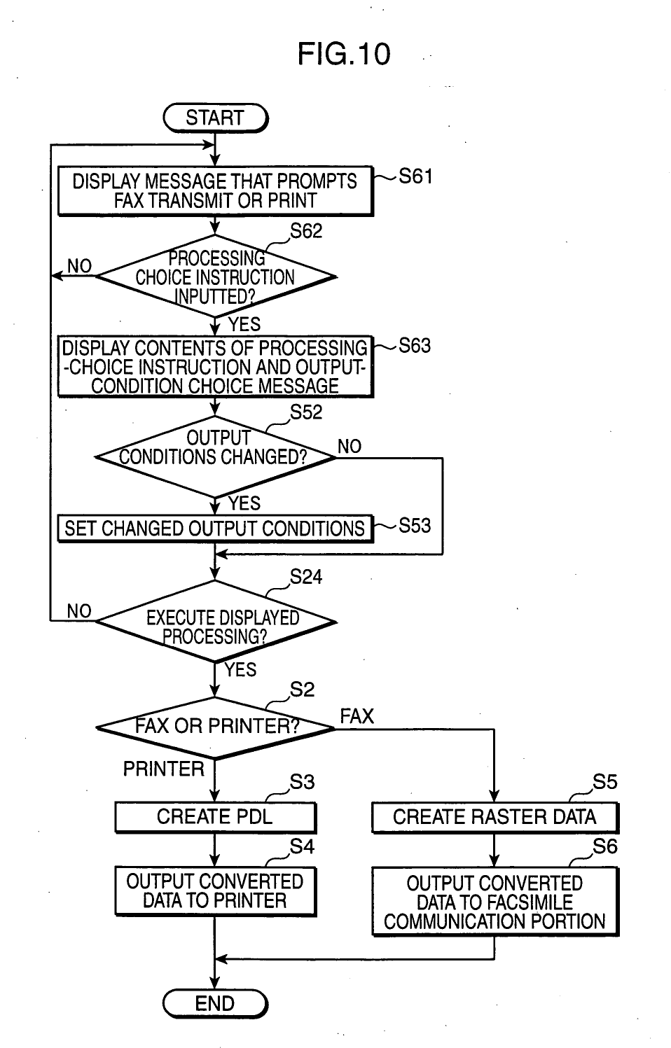

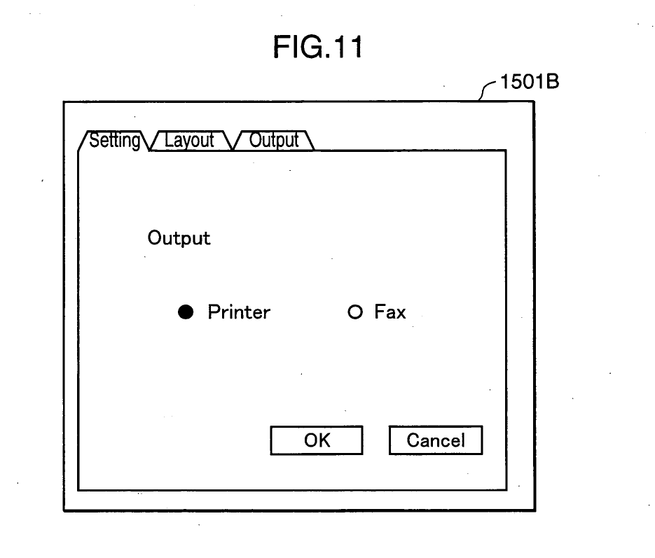

Next, printing and faxing according to a sixth embodiment of the present invention will be described which is executed by the PC 1 in which an instruction acceptance program is installed. FIG. 10 is a flow chart according to the sixth embodiment, showing faxing and printing by the PC 1 in which the instruction acceptance program is installed. FIG. 11 is a representation, showing an example of a display screen which prompts a user to choose faxing or printing. Herein, the same characters and numerals as those in the flow chart of each figure described earlier are given in its identical processing, and thus, their description is omitted.

In this sixth embodiment, for example, as shown in FIG. 11, there is only a display which prompts a user to choose printing or faxing on a display screen 1501B. After the user makes his/her choice, the confirmation screen 1506 or 1509 for confirming whether the chosen printing or faxing should be executed, which is the same as the above described confirmation screen in FIG. 9A or 9B, makes a display which prompts the user to set the items which have to be set for executing each processing. On this display screen, if the user designates the display part of “Printer” or “Fax”, using the operation portion 140 (such as a mouse pointer), then the displayed processing is designed to be executed.

A description is given along the flow chart of FIG. 10. First, a user gives an instruction to operate the instruction acceptance program. As can be seen from the display screen 1501B shown in FIG. 11, the display control portion 101 displays, in the display portion 150, the processing choice message which prompts the user to choose faxing or printing (S61). Then, the user chooses either printing or faxing, using the operation portion 140. If the acceptance portion 102 accepts this choice instruction (i.e., if it is YES at a step S62), then the display control portion 101 allows the display portion 150 to display, in the same way as shown in FIG. 9A or 9(b), the contents (i.e., which processing has been chosen, printing or faxing) of the processing choice instruction, and the confirmation screen 1506 or 1509 which shows the output conditions which have to be set in the chosen processing (S63).

Then, while this confirmation display screen 1506 or 1509 is displayed, then an instruction to set the output conditions, or the like, is accepted (i.e., it is YES at the step S52). Thereby, the control portion 106 changes the output conditions or the like which have already been set, into the contents of the set instruction (S53). Thereafter, the user designates the “Printer” button 1504 or the “Fax” button 1508 of the confirmation screen 1509, then an instruction to execute the print-data processing which is being displayed in the display portion 150 is accepted by the acceptance portion 102 (i.e., it is YES at the step S24) Thus, the acceptance portion 102 accepts this instruction and the output-condition setting which it has accepted at the step S52, as the final instruction. Then, in the'same way as the fifth embodiment, the control portion 106 executes a series of pieces of processing according to each processing (S2 to S6).

Herein, the instruction acceptance program according to the present invention allows the PC 1 (i.e., the CPU 100) to function as: the display control portion 101; the acceptance portion 102; the printing-data conversion portion 103; the faxing-data conversion portion 104; the decision portion 105; the control portion 106; and the output portion 107. However, it is enough that the instruction acceptance program according to the present invention allows it to function only as each portion which is necessary for executing the processing shown in the flow chart of each of the above described figures. For example, when the processing according to the first embodiment is executed, it is enough that the PC 1 functions at least as the display control portion 101 and the acceptance portion 102, so that it can accept the above described final instruction from a user.

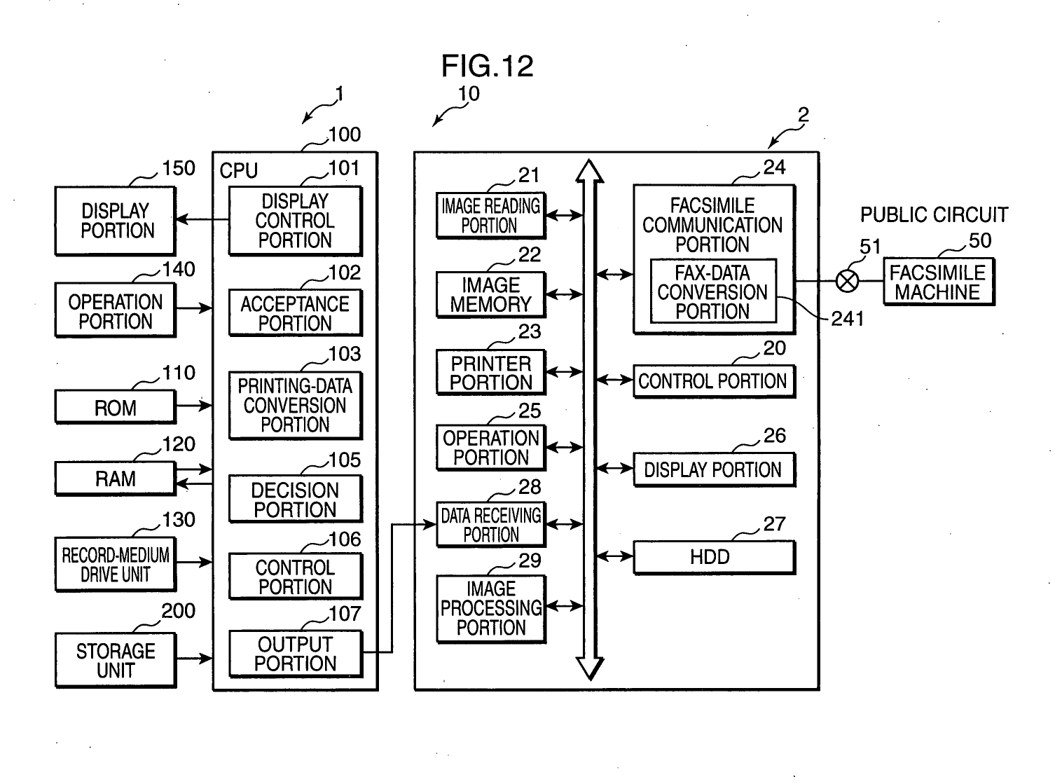

Next, a data processing system according to the present invention will be described. FIG. 12 is a block diagram, showing a substantial configuration of the data processing system according to the present invention. Herein, the same characters and numerals as those in the personal computer 1 shown in FIG. 1 are given to their identical component parts, and thus, their description is omitted.

Next, the personal computer 1 of a data processing system 10 according to the present invention includes only the printing-data conversion portion 103 as a data conversion portion. It is not provided with the faxing-data conversion portion 104. Whichever the instruction from a user which has been accepted by the acceptance portion 102 is, for printing or for faxing, the control portion (i.e., the data-output controlling unit) 106 allows the printing-data conversion portion 103 to convert the print data which is stored in the storage unit 200 into a PDL that is a data format for printing. Herein, when the control portion 106 allows the output portion 107 to output the data which has been converted into the PDL, if the instruction from the user which has been accepted by the acceptance portion 102 is for printing, then it outputs only this PDL data. On the other hand, if the instruction from the user is for faxing, then it outputs this PDL data after information (hereinafter, referred to as the faxing instruction information) on the instruction to execute the faxing has been attached to the PDL data.

A combined machine 2 includes: a control portion (i.e., the operation controlling unit) 20 which controls an operation of each portion of the machine; an image reading portion 21 which has a scanner or the like that reads an original image; an image memory 22 which temporarily stores original-image data that has been read by the image reading portion 21, image data that has been read by the image reading portion 21, or the like; and a printer portion (i.e., the printing unit) 23 which prints out original-image data that has been read by the image reading portion 21, data that has been sent from a personal computer or the like which is connected to a network, or the like.

In addition, the combined machine 2 further includes: a facsimile communication portion (i.e., the faxing unit) 24 which executes various functions necessary for facsimile communication, and transmits and receives image data to and from the external facsimile machine 50, through the public circuit 51; an operation portion 25 which is made up of a transmission-start key, a ten-key, an abbreviated-number key and the like that accepts various operational instructions from an operator; and a display portion 26 which is made up of an LCD (or liquid crystal display) and the like that displays an operational guide or the like for an operator.

Moreover, the combined machine 2 further includes: an HDD 27 which stores image data or the like that has been read by the image reading portion 21; a data receiving portion 28 which receives data from a personal computer or the like which is connected to a network; and an image processing portion 29 which executes image-data editing and manipulation (e.g., encoding and decoding, enlargement and reduction, compression and expansion) processing or the like for the image that has been read by the image reading portion 21.

The above described facsimile communication portion 24 further includes a fax-data conversion portion 241 which converts, into raster data, data that has been received from a personal computer (i.e., the PC 1 according to this embodiment) or the like which is connected to a network, and then, that creates compressed data which is encoded for faxing.

The above described control portion 20 decides whether or not the faxing instruction information is attached to the PDL data that has been received from a personal computer or the like which is connected to a network. If the faxing instruction information is attached to the received PDL data, then it allows the facsimile communication portion 24 to convert and fax the received PDL data, as described above. On the other hand, unless the faxing instruction information is attached to the received PDL data, then it allows the printer portion 23 to print the received PDL data.

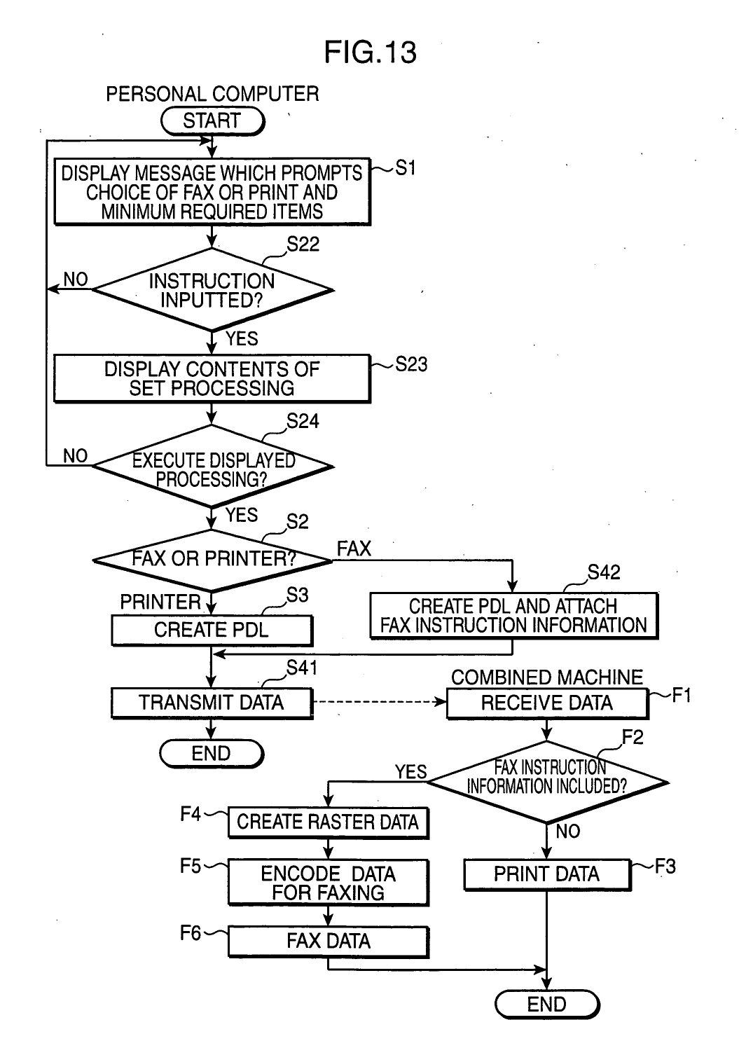

FIG. 13 is a flowchart, showing the flow of processing in the case where printing and faxing are executed by the data processing system 10. Herein, the same characters and numerals as those in the flow chart of each figure described earlier are given in its identical processing, and thus, their description is omitted.

If the final instruction from the user is accepted by the acceptance portion 102 (i.e., it is YES at the step S24), then the control portion 106 judges which of faxing and printing has been chosen by the user (S2). If this final instruction is for printing (i.e., the “printer” at the step S2), then it allows the printing-data conversion portion 103 to convert the print data to be outputted and create PDL data (S3). In addition, if the final instruction is for faxing (i.e., the “fax” at the step S2), then the control portion 106 allows the printing-data conversion portion 103 to convert the print data to be outputted and create PDL data (S3). Then, it attaches the faxing instruction information to the converted data (S42). Then, the control portion 106 allows the output portion 107 to transmit, to the combined machine 2, the PDL data which has been created for printing, or the PDL data which has been created for faxing and which the faxing instruction information has been attached to (S41).

If the data receiving portion 28 of the combined machine 2 receives this data from the PC 1 (F1), then the control portion 20 decides whether or not the faxing instruction information is attached to this received data (F2). If the control portion 20 decides that the faxing instruction information is attached to the received PDL data (i.e., if it is YES at the step F2), then it allows the fax-data conversion portion 241 of the facsimile communication portion 24 to convert the received PDL data into raster data (F4), and create compressed data which is encoded for faxing from this raster data (F5). Then, the control portion 20 allows the facsimile communication portion 24 to transmit the encoded compressed data to the facsimile machine 50 which is the transmission destination (F6).

On the other hand, if the control portion 20 decides that the faxing instruction information is not attached to the received PDL data (i.e., if it is NO at the step F2), then it allows the printer portion 23 to execute printing, using the received PDL data (F3).

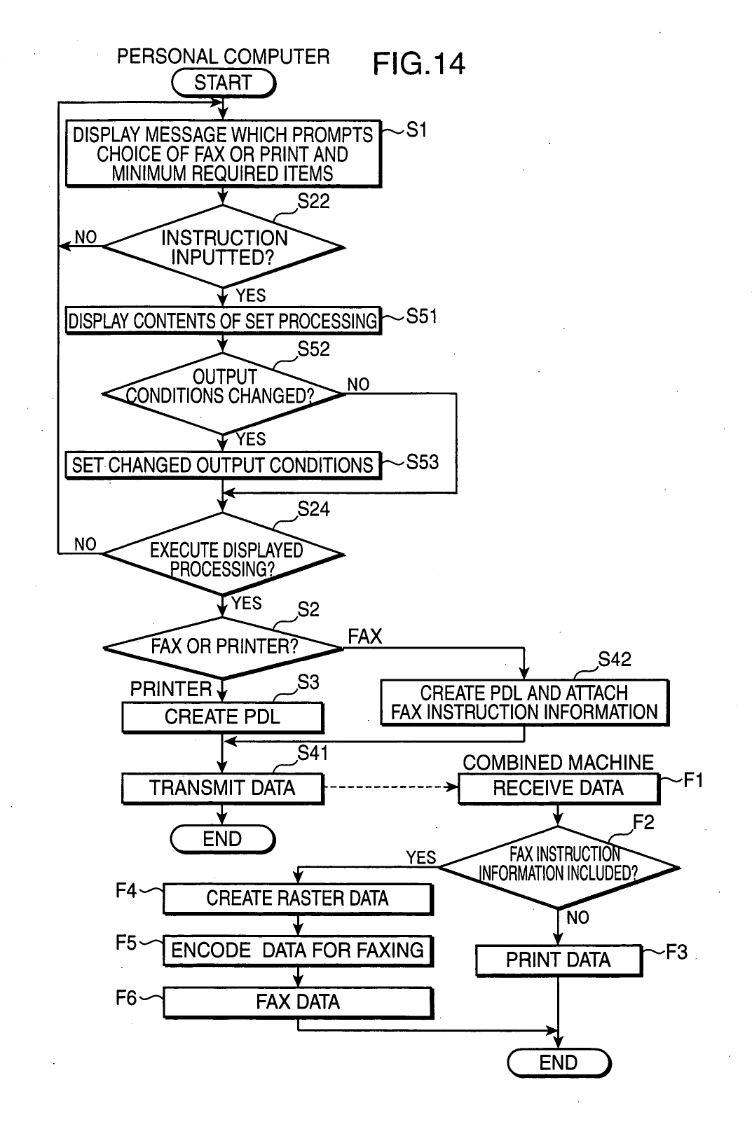

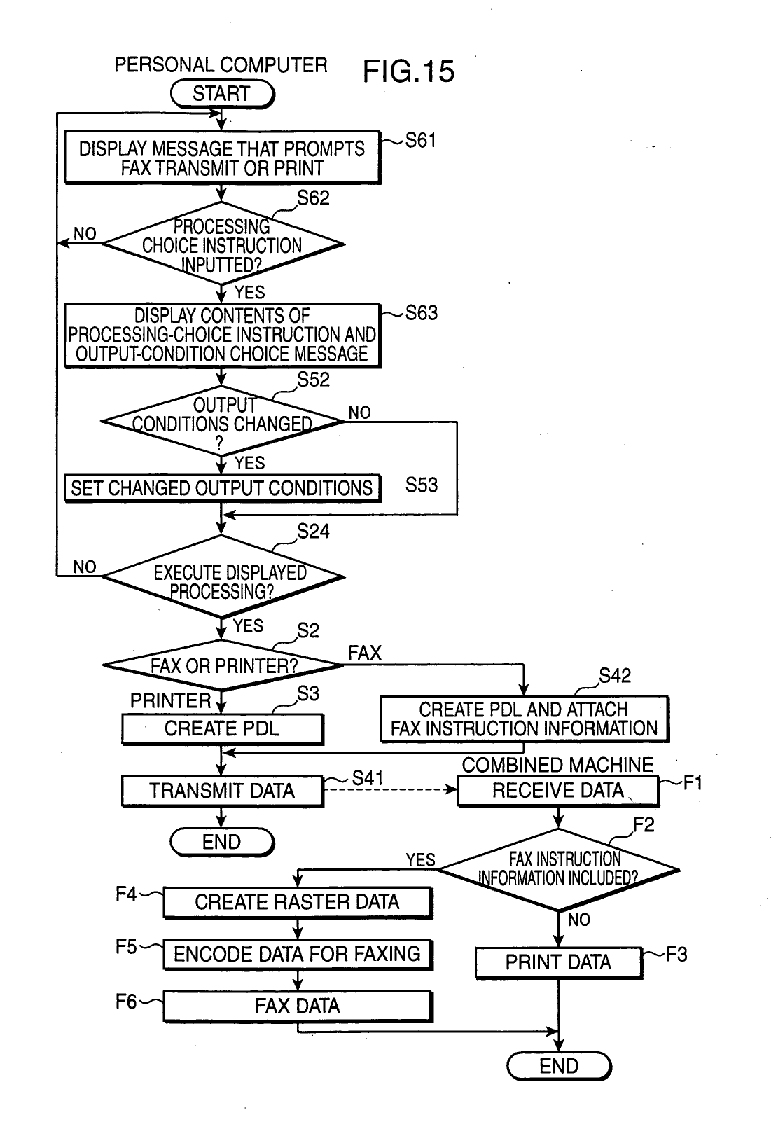

In addition to the above described processing shown in FIG. 13, the data processing system 10 can execute such processing as described below. FIG. 14 is a flow chart according to the second embodiment, showing processing in the case where printing and faxing are executed by the data processing system 10. FIG. 15 is a flow chart according to the third embodiment, showing processing in the case where printing and faxing are executed by the data processing system 10. Herein, the same characters and numerals as those in the flow chart of each figure described earlier are given in its identical processing, and thus, their description is omitted.

For example, as shown in FIG. 14, in the PC 1 of the data processing system 10, the same processing as that of the steps S1 to S24 is executed, as described using FIG. 8. Thus, if the final instruction from the user is accepted by the acceptance portion 102 (i.e., it is YES at the step S24), then the control portion 106 judges which of faxing and printing has been chosen by the user (S2). Based on the contents of this final instruction, the processing of the steps S3, S41 and S42 is executed in the same way as that of FIG. 13. On the side of the combined machine 2, the processing of the steps F1 to F6 is executed.

Furthermore, as shown in FIG. 15, in the PC 1 of the data processing system 10, the same processing as that of the steps S61 to S24 may also be executed, as described using FIG. 10. In that case, if the final instruction from the user is accepted by the acceptance portion 102 (i.e., it is YES at the step S24), then based on the contents of this final instruction, the processing of the steps S3, S41 and S42 is executed in the same way as that of FIG. 13. On the side of the combined machine 2, the processing of the steps F1 to F6 is executed.

Herein, in addition to the above described processing shown in FIG. 13 to FIG. 15, the data processing system 10 can also execute, in the PC 1, the processing from the start to the step S2 shown in FIG. 2 and FIG. 4 for the instruction acceptance program according to the embodiments of the present invention, or the processing of the steps S3, S41 and S42 and F1 to F6 shown in FIG. 13 to FIG. 15 after the processing from the start to the steps S31 and S32 shown in FIG. 7 is executed, though such processing is not particularly shown in any figures.

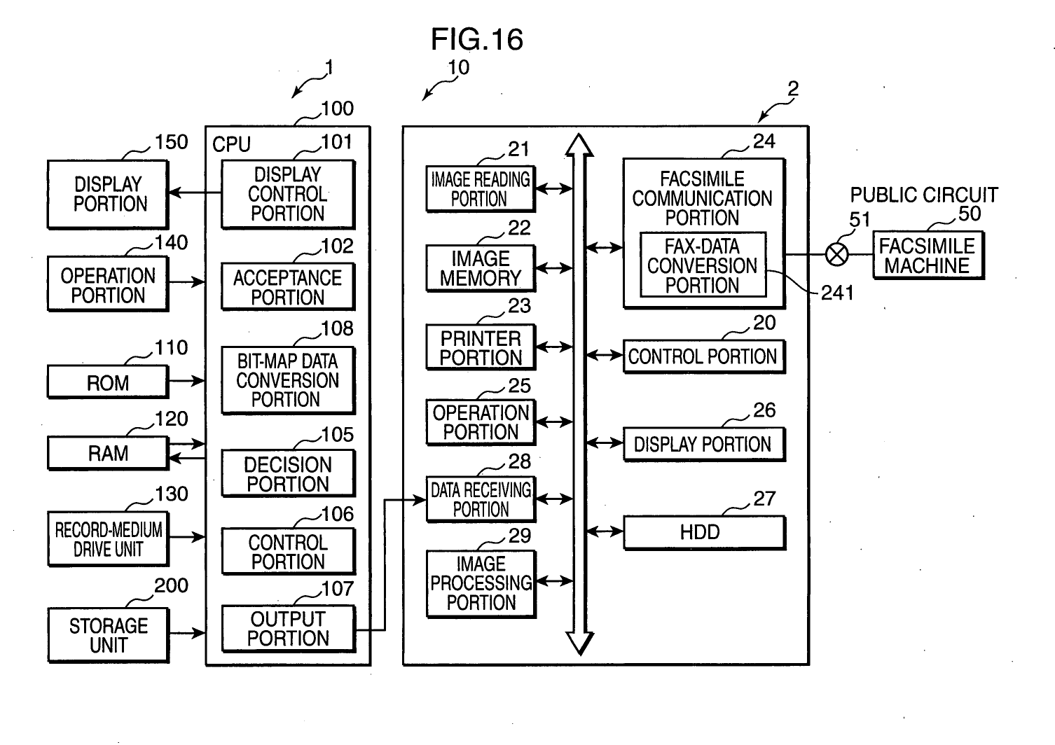

Next, a data processing system according to the second embodiment of the present invention will be described. FIG. 16 is a block diagram, showing a substantial configuration of the data processing system according to the second embodiment. Herein, the same characters and numerals as those in the personal computer 1 shown in FIG. 1 are given to their identical component parts, and thus, their description is omitted.

The PC 1 of a data processing system 11 according to the second embodiment is provided with a bit-map data conversion portion 108 as a data conversion portion. Whichever the instruction from a user which has been accepted by the acceptance portion 102 is, for printing or for faxing, the control portion 106 allows the bit-map data conversion portion 108 to convert the print data which is stored in the storage unit 200 into bit-map data. Herein, when the control portion 106 allows the output portion 107 to output the bit-map data, if the instruction from the user which has been accepted by the acceptance portion 102 is for printing, then it outputs only this bit-map data. On the other hand, if the instruction from the user is for faxing, then it outputs the bit-map data after the faxing instruction information has been attached to the bit-map data.

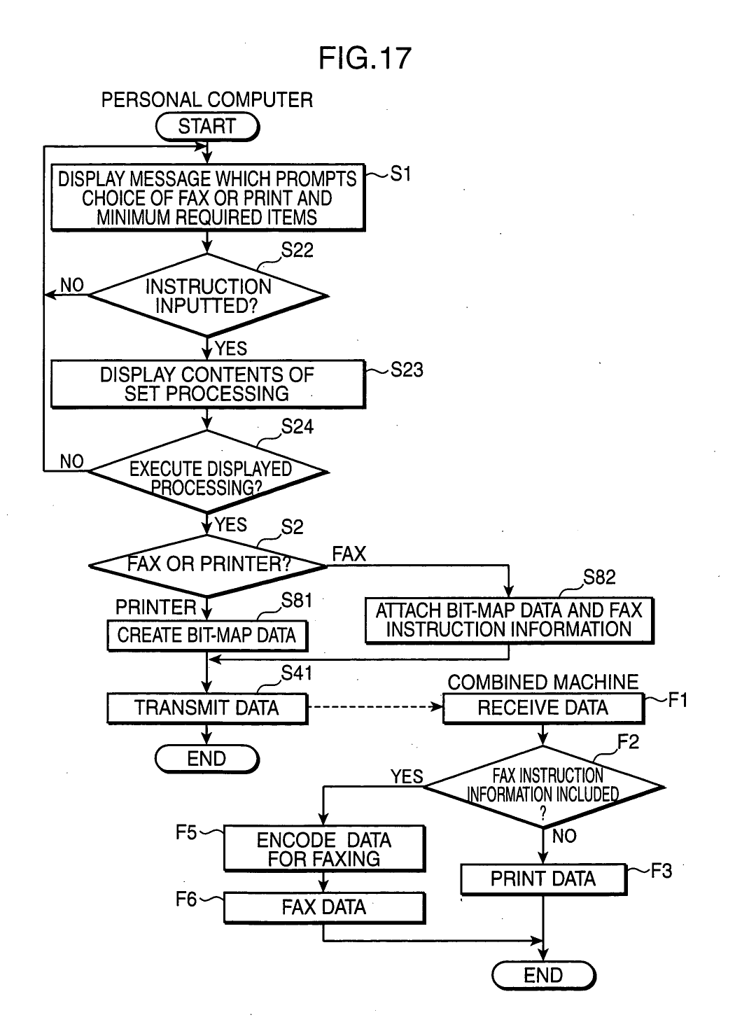

FIG. 17 is a flow chart, showing the flow of processing in the case where printing and faxing are executed by the data processing system 11 according to the second embodiment. Herein, the same characters and numerals as those in the flow chart of each figure described earlier are given in its identical processing, and thus, their description is omitted.

If the final instruction from the user is accepted (i.e., it is YES at the step S24), then the control portion 106 judges which of faxing and printing has been chosen by the user (S2). If this final instruction is for printing (i.e., the “printer” at the step S2), then it allows the bit-map data conversion portion 108 to convert the print data to be outputted into bit-map data (S81). In addition, if the final instruction is for faxing (i.e., the “fax” at the step S2), then the control portion 106 allows the bit-map data conversion portion 108 to convert the print data to be outputted into bit-map data. Then, it attaches the faxing instruction information to the converted data (S82). Then, the control portion 106 allows the output portion 107 to transmit, to the combined machine 2, the bit-map data which has been created for printing, or the bit-map data which has been created for faxing and which the faxing instruction information has been attached to (S41).

If the data receiving portion 28 of the combined machine 2 receives this data from the personal computer 1 (F1), then the control portion 20 decides whether or not the faxing instruction information is attached to this received data (F2). If the control portion 20 decides that the faxing instruction information is attached to the received bit-map data (i.e., if it is YES at the step F2), then from the received bit-map data, it allows the fax-data conversion portion 241 of the facsimile communication portion 24 to create compressed data which is encoded for faxing (F5). Then, the control portion 20 allows the facsimile communication portion 24 to transmit the encoded compressed data to the facsimile machine 50 which is the transmission destination (F6).

On the other hand, if the control portion 20 decides that the faxing instruction information is not attached to the received bit-map data (i.e., if it is NO at the step F2), then it allows the printer portion 23 to execute printing, using the received bit-map data (F3).

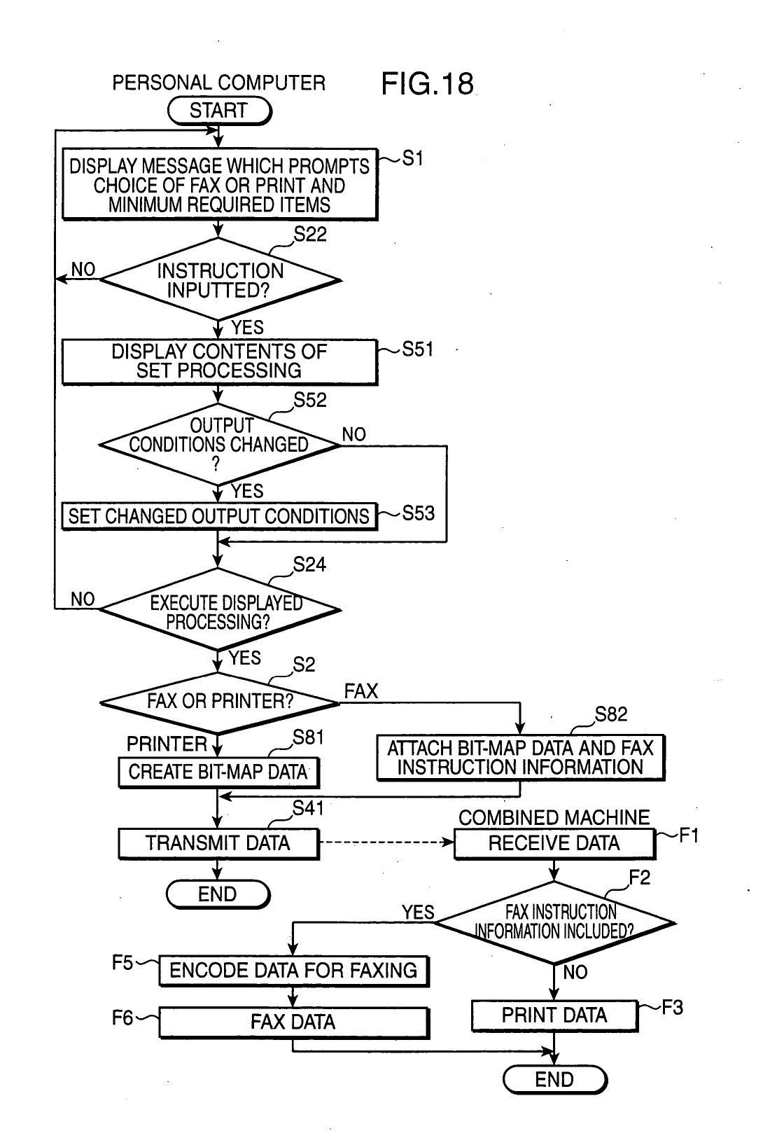

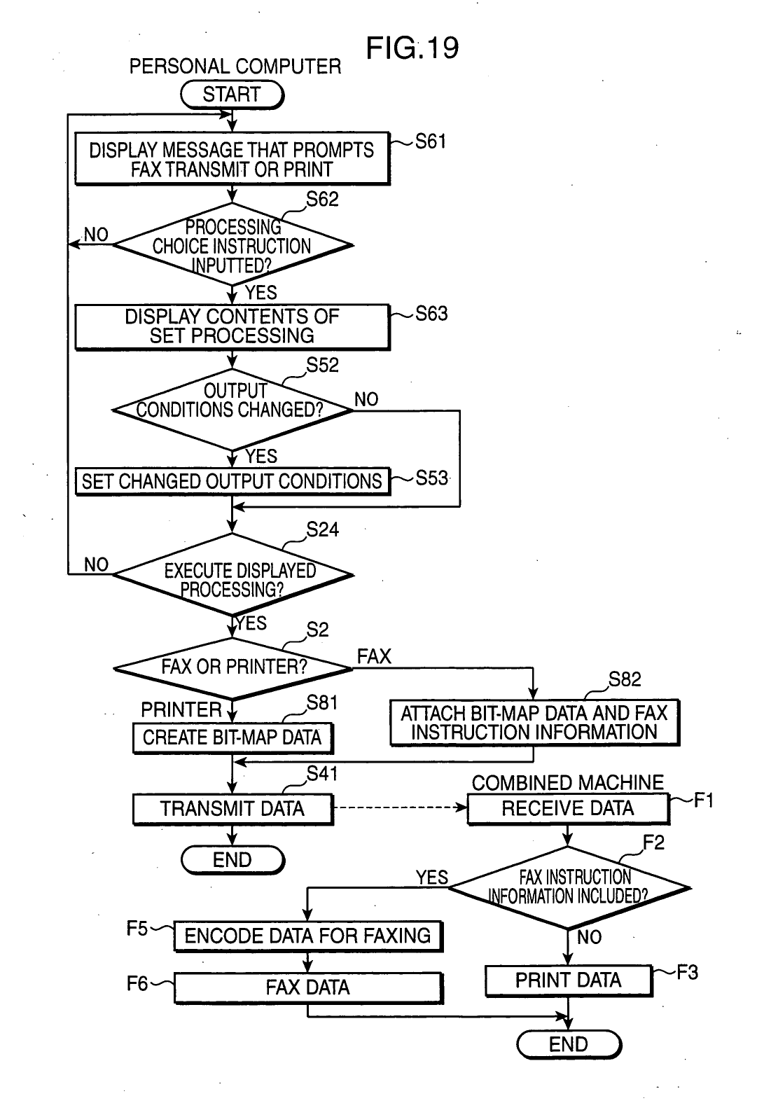

In addition to the above described processing shown in FIG. 17, the data processing system 11 can execute such processing as described below. FIG. 18 is a flow chart according to the second embodiment, showing processing in the case where printing and faxing are executed by the data processing system 11. FIG. 19 is a flow chart according to the third embodiment, showing processing in the case where printing and faxing are executed by the data processing system 11. Herein, the same characters and numerals as those in the flow chart of each figure described earlier are given in its identical processing, and thus, their description is omitted.

For example, as shown in FIG. 18, in the PC 1 of the data processing system 10, the same processing as that of the steps S1 to S24 is executed, as described using FIG. 8. Thus, if the final instruction from the user is accepted by the acceptance portion 102 (i.e., it is YES at the step S24), then the control portion 106 judges which of faxing and printing has been chosen by the user (S2). Based on the contents of this final instruction, the processing of the steps S81 or S82,and S41 is executed in the same way as that of FIG. 17. On the side of the combined machine 2, the processing of the steps F1 to F3, F5 and F6 is executed.

Furthermore, as shown in FIG. 19, in the PC 1 of the data processing system 10, the same processing as that of the steps S61 to S24 is executed, as described using FIG. 10. In that case, if the final instruction from the user is accepted by the acceptance portion 102 (i.e., it is YES at the step S24), then based on the contents of this final instruction, the processing of the steps S81 or S82,and S41 is executed in the same way as that of FIG. 17. On the side of the combined machine 2, the processing of the steps F1 to F3, F5 and F6 is executed.

Herein, in addition to the above described processing shown in FIG. 17 to FIG. 19, the data processing system 11 can also execute, in the PC 1, the processing from the start to the step S2 shown in FIG. 2 and FIG. 4 for the instruction acceptance program according to the embodiments of the present invention, or the processing of the steps S81 or S82, S41, F1 to F3, F5 and F6 shown in FIG. 17 to FIG. 19 after the processing from the start to the steps S31 and S32 shown in FIG. 7 is executed, though such processing is not particularly shown in any figures.

What is claimed is:

1. A recording medium which stores an instruction acceptance program for accepting an instruction to fax, or print, print data which is stored in a storage portion of a computer, based on an instruction by an external input, wherein the instruction acceptance program allows the computer to function as:
a display controlling unit that displays, in a display portion of the computer, a processing choice message which prompts an input of the instruction to fax or print the print data; and
an accepting unit that accepts the instruction to fax or print the print data from the external input when the processing choice message is displayed by the display controlling unit.

2. The recording medium according to claim 1, wherein the instruction acceptance program allows the computer to function further as:
a printing-data converting unit that converts the print data into a data format for printing;
a faxing-data converting unit that converts the print data into a data format for faxing;
an outputting unit that outputs the data which is converted by the printing-data converting unit or the faxing-data converting unit; and
a controlling unit for, based on the instruction which is accepted by the accepting unit, allowing either the printing-data converting unit or the faxing-data converting unit to convert the print data, and allowing the outputting unit to output the converted print data.

3. The recording medium according to claim 2, wherein:
the display controlling unit displays, in the display portion, together with the processing choice message, a required item which should be set at the minimum in both cases where the print data is faxed and printed;
the accepting unit accepts, from the external input, an instruction to set the required item when the required item is displayed by the display controlling unit; and
the controlling unit allows, based on the setting instruction which is accepted by the accepting unit, either the printing-data converting unit or the faxing-data converting unit to convert the print data.

4. The recording medium according to claim 3, wherein:
the instruction acceptance program includes a deciding unit that decides whether or not the required item has been set based on the setting instruction which is accepted by the accepting unit; and
if the deciding unit decides there is a required item in short supply, the display controlling unit displays, in the display portion, the fact that there is the required item.

5. A recording medium which stores an instruction acceptance program for accepting an instruction to fax, or print, print data which is stored in a storage portion of a computer, based on an instruction by an external input, wherein the instruction acceptance program allows the computer to function as:
a display controlling unit that displays, in a display portion of the computer, a processing choice message which prompts an input of the instruction to fax or print the print data;
a first accepting unit that accepts the instruction to fax or print the print data from the external input when the processing choice message is displayed by the display controlling unit;
an instruction-content display controlling unit that displays, in the display portion, whether the instruction which is accepted by the first accepting unit is to fax or print the print data;
a second accepting unit for, when the instruction to fax or print the print data is displayed in the display portion by the instruction-content display controlling unit, accepting, from the external input, an instruction on whether or not is executed this displayed processing; and
a final-instruction accepting unit that accepts, as a final instruction, the instruction which is accepted by the first accepting unit, if the second accepting unit accepts an instruction to execute the processing of faxing or printing the print data which is displayed by the instruction-content display controlling unit.

6. The recording medium according to claim 5, wherein the instruction acceptance program allows the computer to function further as:
a printing-data converting unit that converts the print data into a data format for printing;
a faxing-data converting unit that converts the print data into a data format for faxing;
an outputting unit that outputs the data which is converted by the printing-data converting unit or the faxing-data converting unit; and
a controlling unit for, based on the final instruction which is accepted by the final-instruction accepting unit, allowing either the printing-data converting unit or the faxing-data converting unit to convert the print data, and allowing the outputting unit to output the converted data.

7. The recording medium according to claim 6, wherein if the second accepting unit accepts an instruction not to execute the processing of faxing or printing the print data which is displayed in the display portion by the instruction-content display controlling unit, the controlling unit executes different processing from the processing which is displayed by the instruction-content display controlling unit.

8. The recording medium according to claim 6, wherein the instruction acceptance program allows the computer to function further as:
a required-item display controlling unit that displays, in the display portion, together with the processing choice message, a required item which should be set at the minimum in both cases where the print data is faxed and printed; and
a third accepting unit that accepts, from the external input, an instruction to set the required item when the required item is displayed by the required-item display controlling unit, and
the controlling unit starts to fax or print the print data, based on the setting instruction which is accepted by the third accepting unit.

9. The recording medium according to claim 8, wherein the instruction acceptance program allows the computer to function further as:
a deciding unit that decides whether or not the required item has been set based on the sette instruction which is accepted by the third accepting unit; and
a lacked item display controlling unit for, if the deciding unit decides there is a required item in short supply, displaying the fact that there is the required item in the display portion.

10. A data processing system which faxes, or prints, print data which is stored in a storage portion of a data terminal apparatus, based on an instruction by an external input, comprising: the data terminal apparatus which includes,
a display controlling unit that displays, in a display portion of a computer, a processing choice message which prompts an input of the instruction to fax or print the print data,
a first accepting unit that accepts the instruction to fax or print the print data from the external input when the processing choice message is displayed by the display controlling unit,
an instruction-content display controlling unit that displays, in the display portion, whether the instruction which is accepted by the first accepting unit is to fax or print the print data,
a second accepting unit for, when the instruction to fax or print the print data is displayed in the display portion by the instruction-content display controlling unit, accepting, from the external input, an instruction on whether or not is executed this displayed processing,
a final-instruction accepting unit that accepts, as a final instruction, the instruction which is accepted by the first accepting unit, if the second accepting unit accepts an instruction to execute the processing of faxing or printing the print data which is displayed by the instruction-content display controlling unit,
a printing-data converting unit that converts the print data into a data format for printing,
an outputting unit that outputs the data which is converted by the printing-data converting unit, and
a data-output controlling unit for, if the final instruction which is accepted by the final-instruction accepting unit shows printing processing, then outputting, from the outputting unit, the data which is converted by the printing-data converting unit, and if the final instruction shows faxing processing, then outputting, from the outputting unit, the data which is converted by the printing-data converting unit, and faxing instruction information that shows this data is for faxing which is attached to the data; and
an image forming apparatus which includes,
a faxing unit that converts, into a data format for faxing, the data which is received from the outputting unit of the data terminal apparatus, and faxing the data,
a printing unit that prints the data which is received from the outputting unit of the data terminal apparatus, and
an operation controlling unit for, if the faxing instruction information is attached to the data which is received from the outputting unit of the data terminal apparatus, allowing the faxing unit to execute the data conversion and faxing, based on the received data, and if the faxing instruction information is not attached to the received data, allowing the printing unit to print the received data.

11. A data processing system which faxes, or prints, print data which is stored in a storage portion of a data terminal apparatus, based on an instruction by an external input, comprising: the data terminal apparatus which includes, a display controlling unit that displays, in a display portion of a computer, a processing choice message which prompts an input of the instruction to fax or print the print data,
a first accepting unit that accepts the instruction to fax or print the print data from the external input when the processing choice message is displayed by the display controlling unit,
an instruction-content display controlling unit that displays, in the display portion, whether the instruction which is accepted by the first accepting unit is to fax or print the print data,
a second accepting unit for, when the instruction to fax or print the print data is displayed in the display portion by the instruction-content display controlling unit, accepting, from the external input, an instruction on whether or not is executed this displayed processing,
a final-instruction accepting unit that accepts, as a final instruction, the instruction which is accepted by the first accepting unit, if the second accepting unit accepts an instruction to execute the processing of faxing or printing the print data which is displayed by the instruction-content display controlling unit,
a data converting unit that converts the print data into a bit-map data format,
an outputting unit that outputs the bit-map data which is converted by the data converting unit, and
a data-output controlling unit for, if the final instruction which is accepted by the final-instruction accepting unit shows printing processing, then outputting, from the outputting unit, the data which is converted by the data converting unit, and if the final instruction shows faxing processing, then outputting, from the outputting unit, the data which is converted by the data converting unit, and faxing instruction information that shows this data is for faxing which is attached to the data; and
an image forming apparatus which includes,
a faxing unit that converts, into a data format for faxing, the bit-map data which is received from the outputting unit of the data terminal apparatus, and faxing the data,
a printing unit that prints the bit-map data which is received from the outputting unit of the data terminal apparatus, and
an operation controlling unit that decides whether or not the faxing instruction information is attached to the data which is received from the outputting unit of the data terminal apparatus; if the faxing instruction information is attached to the received bit-map data, allowing the faxing unit to execute the data conversion and faxing, based on the received bit-map data; and if the faxing instruction information is not attached to the received bit-map data, allowing the printing unit to print the received bit-map data.

12. A recording medium which stores an instruction acceptance program for faxing, or printing, print data which is stored in a storage portion of a computer, based on an instruction by an external input, wherein the instruction acceptance program allows the computer to function as:
a display controlling unit that displays, in a display portion provided in the computer, a processing choice message which prompts an input of an instruction to fax or print the print data, and an output-condition setting message which prompts the setting of an output condition for the print data;
a first accepting unit that accepts, using an external operation, an input of a processing choice instruction to fax or print the print data and an input of an output-condition setting instruction to set the output condition for the print data, when the processing choice message and the output-condition setting message are displayed by the display controlling unit;
an instruction-content display controlling unit that displays, in the display portion, whether the processing choice instruction which is accepted by the first accepting unit is to fax or print the print data, and the content of the output condition which is set based on the output-condition setting instruction;
a second accepting unit for, when the content of the output condition which is set based on the output-condition setting instruction is displayed in the display portion by the instruction-content display controlling unit, accepting, from the external input, an output-condition change instruction to change the displayed output condition;
a third accepting unit for, when the instruction to fax or print the print data which is chosen based on the processing choice message is displayed in the display portion by the instruction-content display controlling unit, accepting, from the external input, an instruction on whether or not is executed this displayed processing; and
a final-instruction accepting unit that accepts, as final instructions, the processing choice instruction which is accepted by the first accepting unit and the output-condition setting instruction which is accepted by the first accepting unit and the second accepting unit, if the third accepting unit accepts an instruction to execute the processing of faxing or printing the print data which is displayed by the instruction-content display controlling unit.

13. A recording medium which stores an instruction acceptance program for faxing, or printing, print data which is stored in a storage portion of a computer, based on an instruction by an external input, wherein the instruction acceptance program allows the computer to function as:
a display controlling unit that displays, in a display portion provided in the computer, a processing choice message which prompts an input of an instruction to fax or print the print data;
a first accepting unit that accepts, using an external operation, an input of a processing choice instruction to fax or print the print data when the processing choice message is displayed by the display controlling unit;
an instruction-content display controlling unit that displays, in the display portion, whether the processing choice instruction which is accepted by the first accepting unit is to fax or print the print data, and an output-condition setting message which prompts the setting of an output condition for the print data;
a second accepting unit for, when the processing of faxing or printing the print data which is chosen based on the processing choice instruction and the output-condition setting message are displayed in the display portion by the instruction-content display controlling unit, accepting, from the external input, an output-condition setting instruction to set the output condition for the print data;
a third accepting unit for, when the processing of faxing or printing the print data which is chosen based on the processing choice instruction is displayed in the display portion by the instruction-content display controlling unit, accepting, from the external input, an instruction on whether or not is executed this displayed processing; and
a final-instruction accepting unit that accepts, as final instructions, the processing choice instruction which is accepted by the first accepting unit and the output-condition setting instruction which is accepted by the second accepting unit, if the third accepting unit accepts an instruction to execute the processing of faxing or printing the print data which is displayed by the instruction-content display controlling unit.

14. The recording medium according to claim 12, wherein the instruction acceptance program allows the computer to function further as:
a printing-data converting unit that converts the print data into a data format for printing;
a faxing-data converting unit that converts the print data into a data format for faxing;
an outputting unit that outputs the data which is converted by the printing-data converting unit or the faxing-data converting unit; and
a controlling unit for, based on the final instruction which is accepted by the final-instruction accepting unit, allowing either the printing-data converting unit or the faxing-data converting unit to convert the print data, and allowing the outputting unit to output the converted data.

15. The recording medium according to claim 13, wherein the instruction acceptance program allows the computer to function further as:
a printing-data converting unit that converts the print data into a data format for printing;
a faxing-data converting unit that converts the print data into a data format for faxing;
an outputting unit that outputs the data which is converted by the printing-data converting unit or the faxing-data converting unit; and
a controlling unit for, based on the final instruction which is accepted by the final-instruction accepting unit, allowing either the printing-data converting unit or the faxing-data converting unit to convert the print data, and allowing the outputting unit to output the converted data.

16. The recording medium according to claim 12, wherein, while the instruction-content display controlling unit is displaying the fact that the processing of faxing or printing the print data is to be executed in the display portion of the computer, if the part at which the fact that the processing of faxing or printing the print data is to be executed is displayed is designated by a pointing device provided in the computer, then the third accepting unit accepts an instruction to execute the processing which is designated by the pointing device.

17. A data processing system which faxes, or prints, print data which is stored in a storage portion of a data terminal apparatus, based on an instruction by an external input, comprising: the data terminal apparatus which includes,
a display controlling unit that displays, in a display portion provided in the computer, a processing choice message which prompts an input of an instruction to fax or print the print data, and an output-condition setting message which prompts the setting of an output condition for the print data,
a first accepting unit that accepts, using an external operation, an input of a processing choice instruction to fax or print the print data and an input of an output-condition setting instruction to set the output condition for the print data, when the processing choice message and the output-condition setting message are displayed by the display controlling unit,
an instruction-content display controlling unit that displays, in the display portion, whether the processing choice instruction which is accepted by the first accepting unit is to fax or print the print data, and the content of the output condition which is set based on the output-condition setting instruction,
a second accepting unit for, when the content of the output condition which is set based on the output-condition setting instruction is displayed in the display portion by the instruction-content display controlling unit, accepting, from the external input, an output-condition change instruction to change the displayed output condition,
a third accepting unit for, when the instruction to fax or print the print data which is chosen based on the processing choice message is displayed in the display portion by the instruction-content display controlling unit, accepting, from the external input, an instruction on whether or not is executed this displayed processing,
a final-instruction accepting unit that accepts, as final instructions, the processing choice instruction which is accepted by the first accepting unit and the output-condition setting instruction which is accepted by the first accepting unit and the second accepting unit, if the third accepting unit accepts an instruction to execute the processing of faxing or printing the print data which is displayed by the instruction-content display controlling unit,
a printing-data converting unit that converts the print data into a data format for printing,
an outputting unit that outputs the data which is converted by the printing-data converting unit, and
a data-output controlling unit for, if the final instruction which is accepted by the final-instruction accepting unit shows printing processing, then outputting, from the outputting unit, the data which is converted by the printing-data converting unit, and if the final instruction shows faxing processing, then out putting, from the out putting unit, the data which is converted by the printing-data converting unit, and faxing instruction information that shows this data is for faxing which is attached to the data; and
an image forming apparatus which includes,
a faxing unit that converts, into a data format for faxing, the data which is received from the outputting unit of the data terminal apparatus, and faxing the data,
a printing unit that prints the data which is received from the outputting unit of the data terminal apparatus, and
an operation controlling unit for, if the faxing instruction information is attached to the data which is received from the outputting unit of the data terminal apparatus, allowing the faxing unit to execute the data conversion and faxing, based on the received data, and if the faxing instruction information is not attached to the received data, allowing the printing unit to print the received data.

18. A data processing system which faxes, or prints, print data which is stored in a storage portion of a data terminal apparatus, based on an instruction by an external input, comprising: the data terminal apparatus which includes,
a display controlling unit that displays, in a display portion provided in a computer, a processing choice message which prompts an input of the instruction to fax or print the print data,
a first accepting unit that accepts, using an external operation, an input of a processing choice instruction to fax or print the print data when the processing choice message is displayed by the display controlling unit,
an instruction-content display controlling unit that displays, in the display portion, whether the processing choice instruction which is accepted by the first accepting unit is to fax or print the print data, and an output-condition setting message which prompts the setting of an output condition for the print data,
a second accepting unit for, when the processing of faxing or printing the print data which is chosen based on the processing choice instruction and the output-condition setting message are displayed in the display portion by the instruction-content display controlling unit, accepting, from the external input, an output-condition setting instruction to set the output condition for the print data,
a third accepting unit for, when the processing of faxing or printing the print data which is chosen based on the processing choice instruction is displayed in the display portion by the instruction-content display controlling unit, accepting, from the external input, an instruction on whether or not is executed this displayed processing,
a final-instruction accepting unit that accepts, as final instructions, the processing choice instruction which is accepted by the first accepting unit and the output-condition setting instruction which is accepted by the second accepting unit, if the third accepting unit accepts an instruction to execute the processing of faxing or printing the print data which is displayed by the instruction-content display controlling unit,
a printing-data converting unit that converts the print data into a data format for printing,
an outputting unit that outputs the data which is converted by the printing-data converting unit, and
a data-output controlling unit for, if the final instruction which is accepted by the final-instruction accepting unit shows printing processing, then outputting, from the outputting unit, the data which is converted by the printing-data converting unit, and if the final instruction shows faxing processing, then outputting, from the outputting unit, the data which is converted by the printing-data converting unit, and faxing instruction information that shows this data is for faxing which is attached to the data; and
an image forming apparatus which includes,
a faxing unit that converts, into a data format for faxing, the data which is received from the outputting unit of the data terminal apparatus, and faxing the data,
a printing unit that prints the data which is received from the outputting unit of the data terminal apparatus, and
an operation controlling unit for, if the faxing instruction information is attached to the data which is received from the outputting unit of the data terminal apparatus, allowing the faxing unit to execute the data conversion and faxing, based on the received data, and if the faxing instruction information is not attached to the received data, allowing the printing unit to print the received data.

19. A data processing system which faxes, or prints, print data which is stored in a storage portion of a data terminal apparatus, based on an instruction by an external input, comprising: the data terminal apparatus which includes,
a display controlling unit that displays, in a display portion provided in the computer, a processing choice message which prompts an input of an instruction to fax or print the print data, and an output-condition setting message which prompts the setting of an output condition for the print data,
a first accepting unit that accepts, using an external operation, an input of a processing choice instruction to fax or print the print data and an input of an output-condition setting instruction to set the output condition for the print data, when the processing choice message and the output-condition setting message are displayed by the display controlling unit,
an instruction-content display controlling unit that displays, in the display portion, whether the processing choice instruction which is accepted by the first accepting unit is to fax or print the print data, and the content of the output condition which is set based on the output-condition setting instruction,
a second accepting unit for, when the content of the output condition which is set based on the output-condition setting instruction is displayed in the display portion by the instruction-content display controlling unit, accepting, from the external input, an output-condition change instruction to change the displayed output condition,
a third accepting unit for, when the instruction to fax or print the print data which is chosen based on the processing choice message is displayed in the display portion by the instruction-content display controlling unit, accepting, from the external input, an instruction on whether or not is executed this displayed processing,
a final-instruction accepting unit that accepts, as final instructions, the processing choice instruction which is accepted by the first accepting unit and the output-condition setting instruction which is accepted by the first accepting unit and the second accepting unit, if the third accepting unit accepts an instruction to execute the processing of faxing or printing the print data which is displayed by the instruction-content display controlling unit,
a data converting unit that converts the print data into a bit-map data format,
an outputting unit that outputs the bit-map data which is converted by the data converting unit, and
a data-output controlling unit for, if the final instruction which is accepted by the final-instruction accepting unit shows printing processing, then outputting, from the outputting unit, the data which is converted by the data converting unit, and if the final instruction shows faxing processing, then outputting, from the outputting unit, the data which is converted by the data converting unit, and faxing instruction information that shows this data is for faxing which is attached to the data; and
an image forming apparatus which includes,
a faxing unit that converts, into a data format for faxing, the bit-map data which is received from the outputting unit of the data terminal apparatus, and faxing the data,
a printing unit that prints the bit-map data which is received from the outputting unit of the data terminal apparatus, and
an operation controlling unit that decides whether or not the faxing instruction information is attached to the data which is received from the outputting unit of the data terminal apparatus; if the faxing instruction information is attached to the received bit-map data, allowing the faxing unit to execute the data conversion and faxing, based on the received bit-map data; and if the faxing instruction information is not attached to the received bit-map data, allowing the printing unit to print the received bit-map data.

20. A data processing system which faxes, or prints, print data which is stored in a storage portion of a data terminal apparatus, based on an instruction by an external input, comprising: the data terminal apparatus which includes,
a display controlling unit that displays, in a display portion provided in a computer, a processing choice message which prompts an input of the instruction to fax or print the print data,
a first accepting unit that accepts, using an external operation, an input of a processing choice instruction to fax or print the print data when the processing choice message is displayed by the display controlling unit,
an instruction-content display controlling unit that displays, in the display portion, whether the processing choice instruction which is accepted by the first accepting unit is to fax or print the print data, and an output-condition setting message which prompts the setting of an output condition for the print data,
a second accepting unit for, when the processing of faxing or printing the print data which is chosen based on the processing choice instruction and the output-condition setting message are displayed in the display portion by the instruction-content display controlling unit, accepting, from the external input, an output-condition setting instruction to set the output condition for the print data,
a third accepting unit for, when the processing of faxing or printing the print data which is chosen based on the processing choice instruction is displayed in the display portion by the instruction-content display controlling unit, accepting, from the external input, an instruction on whether or not is executed this displayed processing,
a final-instruction accepting unit that accepts, as final instructions, the processing choice instruction which is accepted by the first accepting unit and the output-condition setting instruction which is accepted by the second accepting unit, if the third accepting unit accepts an instruction to execute the processing of faxing or printing the print data which is displayed by the instruction-content display controlling unit,
a data converting unit that converts the print data into a bit-map data format,
an outputting unit that outputs the bit-map data which is converted by the data converting unit, and
a data-output controlling unit for, if the final instruction which is accepted by the final-instruction accepting unit shows printing processing, then outputting, from the outputting unit, the data which is converted by the data converting unit, and if the final instruction shows faxing processing, then outputting, from the outputting unit, the data which is converted by the data converting unit, and faxing instruction information that shows this data is for faxing which is attached to the data; and
an image forming apparatus which includes,
a faxing unit that converts, into a data format for faxing, the bit-map data which is received from the outputting unit of the data terminal apparatus, and faxing the data,
a printing unit that prints the bit-map data which is received from the outputting unit of the data terminal apparatus, and
an operation controlling unit that decides whether or not the faxing instruction information is attached to the data which is received from the outputting unit of the data terminal apparatus; if the faxing instruction information is attached to the received bit-map data, allowing the faxing unit to execute the data conversion and faxing, based on the received bit-map data; and if the faxing instruction information is not attached to the received bit-map data, allowing the printing unit to print the received bit-map data.
